(19) United States
(12) Patent Application Publication
(10) Pub. No.: US 2022/0405553 A1
(43) Pub. Date: Dec. 22, 2022

(54) SPARSE IMAGE PROCESSING

(71) Applicant: Meta Platforms Technologies, LLC, Menlo Park, CA (US)

(72) Inventors: Ziyun Li, Redmond, WA (US); Xinqiao Liu, Medina, WA (US); Yiming Gan, Rochester, NY (US)

(21) Appl. No.: 17/833,402

(22) Filed: Jun. 6, 2022

Related U.S. Application Data
(60) Provisional application No. 63/213,249, filed on Jun. 22, 2021.

(51) Int. Cl. G06N 3/04; G06N 3/063; H04N 5/351; H04N 5/378; G06F 9/50

(52) U.S. Cl. CPC G06N 3/0481; G06N 3/063; H04N 5/351; H04N 5/378; G06F 9/5027

(57) ABSTRACT

In one example, an apparatus comprises: a memory to store input data and weights, the input data comprising groups of data elements, each group being associated with a channel of channels, the weights comprising weight tensors, each weight tensor being associated with a channel of the channels; a data sparsity map generation circuit configured to generate, based on the input data, a channel sparsity map and a spatial sparsity map, the channel sparsity map indicating channels associated with first weights tensors to be selected, the spatial sparsity map indicating spatial locations of first data elements; a gating circuit configured to: fetch, based on the channel sparsity map and the sparsity map, the first weights tensors and the first data elements from the memory; and a processing circuit configured to perform neural network computations on the first data elements and the first weights tensors to generate a processing result.

### CROSS-REFERENCE TO RELATED APPLICATIONS

This application claims priority to U.S. Provisional Patent Application 63/213,249, filed Jun. 22, 2021, titled “Sparse Image Processing,” the entirety of which is hereby incorporated by reference.

### BACKGROUND

A typical image sensor includes an array of pixel cells. Each pixel cell may include a photodiode to sense light by converting photons into charge (e.g., electrons or holes). The charge converted at each pixel cell can be quantized to become a digital pixel value, and an image can be generated from an array of digital pixel values, with each digital pixel value representing an intensity of light of a particular wavelength range captured by a pixel cell.

The images generated by the image sensor can be processed to support different applications such as, for example, a virtual-reality (VR) application, an augmented-reality (AR), or a mixed reality (MR) application. An image processing operation can then be performed on the images to, for example, detect a certain object of interest and its locations in the images. Based on the detection of the object as well as its locations in the images, the VR/AR/MR application can generate and update, for example, virtual image data for displaying to the user via a display, audio data for outputting to the user via a speaker, etc., to provide an interactive experience to the user.

To improve spatial and temporal resolution of an imaging operation, an image sensor typically includes a large number of pixel cells to generate high-resolution images. The image sensor can also generate the images at a high frame rate. The generation of high-resolution images at a high frame rate, as well as the transmission and processing of these high-resolution images, can lead to huge power consumption by the image sensor and by the image processing operation. Moreover, given that typically only a small subset of the pixel cells receives light from the object of interest, substantial computation and memory resources, as well as power, may be used in generating, transmitting, and processing pixel data that are not useful for the object detection/tracking operation, which degrades the overall efficiency of the image sensing and processing operations.

### SUMMARY

The present disclosure relates to an image processor. More specifically, and without limitation, this disclosure relates to techniques to perform sparse image processing operations.

In some examples, an apparatus is provided. The apparatus comprises: a memory configured to store input data and weights, the input data comprising a plurality of groups of data elements, each group being associated with a channel of a plurality of channels, the weights comprising a plurality of weight tensors, each weight tensor being associated with a channel of the plurality of channels. The apparatus further includes a data sparsity map generation circuit configured to generate, based on the input data, a data sparsity map comprising a channel sparsity map and a spatial sparsity map, the channel sparsity map indicating one or more channels associated with one or more first weights tensors to be selected from the plurality of weight tensors, the spatial sparsity map indicating spatial locations of first data elements to be selected from the plurality of groups of data elements. The apparatus further includes a gating circuit configured to: fetch, based on the channel sparsity map, the one or more first weights tensors from the memory; and fetch, based on the spatial sparsity map, the first data elements from the memory. The apparatus also includes a processing circuit configured to perform, using a neural network, computations on the first data elements and the one or more first weights tensors to generate a processing result of the input data.

In some aspects, the neural network comprises a first neural network layer and a second neural network layer. The gating circuit comprises a first gating layer and a second gating layer. The first gating layer is configured to perform, based on a first data sparsity map generated based on the plurality of groups of data elements, at least one of: a first channel gating operation on the plurality of weight tensors to provide first weights of the one or more first weights tensors to the first neural network layer, or a first spatial gating operation on the plurality of groups of data elements to provide first input data including the first data elements to the first neural network layer. The first neural network layer is configured to generate first intermediate outputs based on the first input data and the first weights, the first intermediate outputs having first groups of data elements associated with different channels. The second gating layer is configured to perform, based on a second data sparsity map generated based on the first intermediate outputs, at least one of: a second channel gating operation on the plurality of weight tensors to provide second weights of the one or more first weights tensors to the second neural network layer, or a second spatial gating operation on the first intermediate outputs to provide second input data to the second neural network layer. The second neural network layer is configured to generate second intermediate outputs based on the second input data and the second weights, the second intermediate outputs having second groups of data elements associated with different channels. the processing result is generated based on the second intermediate outputs.

In some aspects, the neural network further comprises a third neural network layer. The gating circuit further comprises a third gating layer. The third gating layer is configured to perform, based on a third data sparsity map generated based on the second intermediate outputs, at least one of: a third channel gating operation on the plurality of weight tensors to provide third weights of the one or more first weights tensors to the third neural network layer, or a third spatial gating operation on the second intermediate outputs to provide third input data to the third neural network layer. The third neural network layer is configured to generate outputs including the processing result based on the third input data and the third weights.

In some aspects, the second neural network layer comprises a convolution layer. The third neural network layer comprises a fully connected layer.

In some aspects, the first gating layer is configured to perform the first spatial gating operation but not the first channel gating operation. The second gating layer is configured to perform the second spatial gating operation but not the second channel gating operation. The third gating layer is configured to perform the third channel gating operation but not the third spatial gating operation.

In some aspects, the second data sparsity map is generated based on a spatial tensor, the spatial tensor being generated based on performing a channel-wise pooling operation between the first groups of data elements of the first intermediate outputs associated with different channels. The third data sparsity map is generated based on a channel tensor, the channel tensor being generated based on performing an inter-group pooling operation within each group of the second groups of data elements of the second intermediate outputs, such that the channel tensor is associated with the same channels as the second intermediate outputs.

In some aspects, the neural network is a first neural network. The data sparsity map generation circuit is configured to use a second neural network to generate the data sparsity map.

In some aspects, the data sparsity map comprises an array of binary masks, each binary mask having one of two values. The data sparsity map generation circuit is configured to: generate, using the second neural network, an array of soft masks, each soft mask corresponding to a binary mask of the array of binary masks and having a range of values; and generate the data sparsity map based on applying a differentiable function that approximates an arguments of the maxima (argmax) function to the array of soft masks.

In some aspects, the data sparsity map generation circuit is configured to: add random numbers from a Gumbel distribution to the array of soft masks to generate random samples of the array of soft masks; and apply a soft max function on the random samples to approximate the argmax function.

In some aspects, the data sparsity map generation circuit, the gating circuit, and the processing circuit are parts of a neural network hardware accelerator. The memory is an external memory external to the neural network hardware accelerator.

In some aspects, the neural network hardware accelerator further includes a local memory, a computation engine, an output buffer, and a controller. The controller is configured to: fetch, based on the channel sparsity map, the one or more first weights tensors from the external memory; fetch, based on the spatial sparsity map, the first data elements from the external memory; store the one or more first weights tensors and the first data elements at the local memory; control the computation engine to fetch the one or more first weights tensors and the first data elements from the local memory, and to perform the computations of a first neural network layer of the neural network to generate intermediate outputs; control the output buffer to perform post-processing operations on the intermediate outputs; and store the post-processed intermediate outputs at the external memory to provide inputs for a second neural network layer of the neural network.

In some aspects, the local memory further stores an address table that maps between addresses of the local memory and addresses of the external memory. The controller is configured to, based on the address table, fetch the one or more first weights tensors and the first data elements from the external memory and store the one or more first weights tensors and the first data elements at the local memory.

In some aspects, the address table comprises a translation lookaside buffer (TLB). The TLB includes multiple entries, each entry being mapped to an address of the local memory, and each entry further storing an address of the external memory.

In some aspects, the controller is configured to: receive a first instruction to store a data element of the plurality of groups of data elements at a first address of the local memory, the data element having a first spatial location in the plurality of groups of data elements; determine, based on the spatial sparsity map, that the data element at the first spatial location is to be fetched; and based on determining that the data element at the first spatial location is to be fetched: retrieve a first entry of the address table mapped to the first address; retrieve a second address stored in the first entry; fetch the data element from the second address of the external memory; and store the data element at the first address of the local memory.

In some aspects, the controller is configured to: receive a second instruction to store a weight tensor of the plurality of weight tensors at a third address of the local memory, the weight tensor being associated with a first channel of the plurality of channels; determine, based on the channel sparsity map, that a weight tensor of the first channel is to be fetched; and based on determining that the weight tensor of the first channel is to be fetched: retrieve a second entry of the address table mapped to the third address; retrieve a fourth address stored in the second entry; fetch the weight tensor from the fourth address of the external memory; and store the weight tensor at the third address of the local memory.

In some aspects, the neural network is a first neural network. The channel sparsity map is a first channel sparsity map. The spatial sparsity map is a first spatial sparsity map. The controller is configured to: control the output buffer to generate a channel tensor based on performing an inter-group pooling operation on the intermediate outputs; control the output buffer to generate a spatial tensor based on performing a channel-wise pooling operation on the intermediate outputs; store the channel tensor, the spatial tensor, and the intermediate outputs at the external memory; fetch the channel tensor and the spatial tensor from the external memory; fetch weights associated with a channel sparsity map neural network and a spatial sparsity map neural network from the external memory; control the computation engine to perform computations of the channel sparsity map neural network on the channel tensor to generate a second channel sparsity map; control the computation engine to perform computations of the spatial sparsity map neural network on the spatial tensor to generate a second spatial sparsity map; and perform at least one of: a channel gating operation on the plurality of weight tensors to fetch second weights of the one or more first weights tensors to a second neural network layer of the first neural network, or a spatial gating operation on the intermediate outputs to provide second input data to the second neural network layer of the first neural network.

In some aspects, the apparatus further comprises a programmable pixel cell array and a programming circuit. The input data is first input data. The programming circuit is configured to: determine a region of interest based on the processing result from the processing circuit; generate a programming signal indicating the region of interest to select a subset of pixel cells of the programmable pixel cell array to perform light sensing operations to perform a sparse image capture operation; and transmit the programming signal to the programmable pixel cell array to perform the sparse image capture operation to capture second input data.

In some aspects, the data sparsity map generation circuit, the gating circuit, the processing circuit, and the programmable pixel cell array are housed within a chip package to form a chip.

In some examples, a method is provided. The method comprise: storing, at a memory, input data and weights, the input data comprising a plurality of groups of data elements, each group being associated with a channel of a plurality of channels, the weights comprising a plurality of weight tensors, each weight tensor being associated with a channel of the plurality of channels; generating, based on the input data, a data sparsity map comprising a channel sparsity map and a spatial sparsity map, the channel sparsity map indicating one or more channels associated with one or more first weights tensors to be selected from the plurality of weight tensors, the spatial sparsity map indicating spatial locations of first data elements to be selected from the plurality of groups of data elements; fetching, based on the channel sparsity map, the one or more first weights tensors from the memory; fetching, based on the spatial sparsity map, the first data elements from the memory; and performing, using a neural network, computations on the first data elements and the one or more first weights tensors to generate a processing result of the input data.

In some aspects, the neural network is a first neural work. The data sparsity map is generated using a second neural network.

### BRIEF DESCRIPTION OF THE DRAWINGS

Illustrative examples are described with reference to the following figures.

FIG. 1A and FIG. 1B are diagrams of an example of a near-eye display.

FIG. 2 is an example of a cross section of the near-eye display.

FIG. 3 illustrates an isometric view of an example of a waveguide display with a single source assembly.

FIG. 4 illustrates a cross section of an example of the waveguide display.

FIG. 5 is a block diagram of an example of a system including the near-eye display.

FIG. 6A, FIG. 6B, FIG. 6C, and FIG. 6D illustrate examples of an image sensor and its operations.

FIG. 7A and FIG. 7B illustrate examples of applications supported by the output of image sensor of FIG. 6A-FIG. 6D.

FIG. 8A, FIG. 8B, FIG. 8C, FIG. 8D, FIG. 8E, and FIG. 8F illustrate examples of image processing operations to support the applications illustrated in FIG. 7A and FIG. 7B.

FIG. 9A, FIG. 9B, FIG. 9C, and FIG. 9D illustrate examples of a dynamic sparsity image processor and their operations.

FIG. 10A, FIG. 10B, and FIG. 10C illustrate example internal components of the dynamic sparsity image processor of FIG. 9A-FIG. 9D and their operations.

FIG. 11A, FIG. 11B, FIG. 11C, FIG. 11D, FIG. 11E, and FIG. 11F illustrate examples of a neural network hardware accelerator that implements the dynamic sparsity image processor of FIG. 9A-FIG. 9D and their operations.

FIG. 12A and FIG. 12B illustrate examples of an imaging system including the dynamic sparsity image processor of FIG. 9A-FIG. 9D

FIG. 13 illustrates a flowchart of an example process of performing a sparse image processing operation.

The figures depict examples of the present disclosure for purposes of illustration only. One skilled in the art will readily recognize from the following description that alternative examples of the structures and methods illustrated may be employed without departing from the principles of or benefits touted in this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth to provide a thorough understanding of certain inventive examples. However, it will be apparent that various examples may be practiced without these specific details. The figures and description are not intended to be restrictive.

As discussed above, an image sensor can sense light to generate images. The image sensor can sense light of different wavelength ranges from a scene to generate images of different channels (e.g., images captured from light of different wavelength ranges). The images can be processed by an image processor to support different applications, such as VR/AR/MR applications. For example, the image processor can perform an image processing operation on the images to detect an object of interest/target object and its locations in the images. The detection of the target object can be based on detection of a pattern of features of the target object from the images. A feature can be represented by, for example, a pattern of light intensities for different wavelength ranges. Based on the detection of the target object, the VR/AR/MR applications can generate output contents (e.g., virtual image data for displaying to the user via a display, audio data for outputting to the user via a speaker, etc.) to provide an interactive experience to the user.

The accuracy of the object detection operation can be improved using various techniques. For example, the image sensor can include a large number of pixel cells to generate high-resolution input images to improve the spatial resolutions of the images, as well as the spatial resolution of the features captured in the images. Moreover, the pixel cells can be operated to generate the input images at a high frame rate to improve the temporal resolutions of the images. The improved resolutions of the images allow the image processor to extract more detailed features to perform the object detection operation. In addition, the image processor can employ a trained machine learning model to perform the object detection operation. The machine learning model can be trained, in a training operation, to learn about the features of the target object from a large set of training images. The training images can reflect, for example, the different operation conditions/environments in which the target object is captured by an image sensor, as well as other objects that are to be distinguished from the target object. The machine learning model can then apply model parameters learnt from the training operation to the input image to perform the object detection operation. Compared with a case where the image processor uses a fixed set of rules to perform the object detection operation, a machine learning model can adapt its model parameters to reflect complex patterns of features learnt from the training images, which can improve the robustness of the image processing operation.

One example of a machine learning model can include a deep neural network (DNN). A DNN can include multiple cascading layers, including an input layer, one or more intermediate layers, and an output layer. The input layer can receive an input image and generate intermediate output data, which are then processed by the intermediate layers followed by the output layer. The output layer can generate classification outputs indicating, for example, a likelihood of each pixel in the input image being part of a target object. Each neural network layer can be associated with a set of weights, with each set associated with a particular channel. Depending on the connection between a neural network layer and a prior layer, the neural network layer can be configured as a convolution layer to perform a convolution operation on intermediate output data of a previous layer, or as a fully connected layer to perform a classification operation. The weights of each neural network layer can be adjusted, in a training operation, to reflect patterns of features of the target object learnt from a set of training images. The sizes of each neural network layer, as well as the number of neural network layers in the model, can be expanded to enable the neural network to process high resolution images and to learn and detect more complex and high-resolution features patterns, both of which can improve the accuracy of the object detection operation.

A DNN can be implemented on a hardware system that provides computation and memory resources to support the DNN computations. For example, the hardware system can include a memory to store the input data, output data, and weights of each neural network layer. Moreover, the hardware system can include computation circuits, such as a general-purpose central processing unit (CPU), dedicated arithmetic hardware circuits, etc., to perform the computations for each neural network layer. The computation circuits can fetch the input data and weights for a neural network layer from the memory, perform the computations for that neural network layer to generate output data, and store the output data back to the memory. The output data can be provided as input data for a next neural network layer, or as classification outputs of the overall neural network for the input image.

While the accuracy of the image processing operation can be improved by increasing the resolutions of the input images, performing image processing operations on high resolution images can require substantial resources and power, which can create challenges especially in resource-constrained devices such as mobile devices. Specifically, in a case where a neural network is used to perform the image processing operation, the sizes of the neural network layers, as well as the number of the neural network layers, may be increased to process high resolution images and to learn and detect complex and high-resolution feature patterns. But the expanded neural network layer can lead to more computations to be performed by the computation circuits for the layer, while increasing the number of neural network layers can also increase the overall computations performed for the image processing operation. Moreover, as the computations rely on input data and weights fetched from the memory, as well as storage of output data at the memory, expanding the neural network may also increase the data transfer between the memory and the computation circuits.

In addition, typically the target object to be detected is only represented by a small subset of pixels, and the pixels of the target object may be associated with only a small subset of the wavelength channels (e.g., having a small set of colors), leading to spatial sparsity and channel sparsity in the images. Therefore, substantial computation and memory resources, as well as power, may be used in generating, transmitting, and processing pixel data that are not useful for the object detection/tracking operation, which further degrades the overall efficiency of the image processing operations. All these can make it challenging to perform high resolution image processing operations on resource-constrained devices.

This disclosure proposes a dynamic sparse image processing system that can address at least some of the issues above. In some examples, the dynamic sparse image processing system includes a data sparsity map generation circuit, a gating circuit, and a processing circuit. The data sparsity map generation circuit can receive input data, and generate a data sparsity map based on the input data. The gating circuit can select, based on the data sparsity map, a first subset of the input data, and provide the first subset of the input data to the image processing circuit for processing. The input data may include a plurality of groups of data elements, with each group being associated with a channel of a plurality of channels. Each group of data elements may form a tensor. In some examples, the input data may include image data, with each group of data elements representing an image of a particular wavelength channel, and a data element can represent a pixel value of the image. In some examples, the input data may also include features of a target object, with each group of data elements indicating absence/presence of certain features and the locations of the features in an image. The input data can be stored (e.g., by a host, by the dynamic sparse image processing system, etc.) in a memory that can be part of or external to the dynamic sparse image processing system.

In some examples, the data sparsity map includes a channel sparsity map and a spatial sparsity map. The channel sparsity map may indicate one or more channels associated with one or more groups of data elements to be selected from the plurality of groups of data elements to support channel gating, whereas the spatial sparsity map can indicate spatial locations of the data elements in the one or more groups of data elements that are selected to be part of the first subset of the input data to support spatial gating. The spatial locations may include, for example, pixel locations in an image, coordinates in an input data tensor, etc. In some examples, both the channel sparsity map and the spatial sparsity map can include an array of binary masks, with each binary mask having one of two binary values (e.g., 0 and 1). The channel sparsity map can include a one-dimensional array of binary masks corresponding to the plurality of channels, with each binary mask indicating whether a particular channel is selected. Moreover, the spatial sparsity map can include a one-dimensional or two-dimensional array of binary masks corresponding to a group of data elements, with each binary mask indicating whether a corresponding data element of each group is selected to be part of the first subset of the input data.

The gating circuit can selectively fetch, based on the data sparsity map, the first subset of the input data from the memory, and then the processing circuit can perform a sparse image processing operation on the first subset of the input data to generate a processing result. The gating circuit can selectively fetch the data elements of the input data indicated in the spatial sparsity map to perform spatial gating. In some examples, the gating circuit can also skip data elements that are indicated in the spatial sparsity map but associated with channels not selected in the channel sparsity map. In a case where the image processing circuit uses an image processing neural network to perform the sparse image processing operation, the image processing circuit can also fetch a first subset of the weights of the image processing neural network from the memory, as part of channel gating. The image processing circuit can also skip fetching the remaining subset of the input data and the remaining subset of the weights from the memory. Such arrangements can reduce the data transfer between the memory and the image processing circuit, which can reduce power consumption. In some examples, the image processing circuit can also include bypass circuits to skip computations involving the remaining subsets of the input data and the weights. All these can reduce the memory data transfer and computations involved in the image processing operation, which in turn can reduce the power consumption of the sparse image processing operation.

The data sparsity map generation circuit can dynamically generate the data sparsity map based on the input data, which can increase the likelihood that the first subset of the input data being selected contains the target object. In some examples, the data sparsity map can represent expected spatial locations of pixels of a target object in an input image, as well as the expected wavelength channels associated with those pixels. But the expected spatial locations of the pixels as well as their associated wavelength channels may change between different input images. For example, the spatial location of the target object may change between different input images due to a movement of the target object, a movement of the camera, etc. Moreover, the wavelength channels of the pixels of the target object may also change between different input images due to, for example, a change in the operation conditions (e.g., different lighting conditions). In all these cases, dynamically updating the data sparsity map based on the input data can increase the likelihood that the image processing circuit processes a subset of input data that are useful for detecting the target object, and discard the rest of the input data that are not part of the target object, which can improve the accuracy of the sparse image processing operation while reducing power consumption.

In some examples, in addition to dynamically updating the spatial sparsity map and the channel sparsity map based on the input data, the data sparsity map generation circuit can also generate a different spatial sparsity map and a different channel sparsity map for each layer of the image processing neural network. In some examples, spatial gating may be performed for some neural network layers, whereas channel gating may be performed for some other neural network layers. In some examples, a combination of both spatial gating and channel gating may be performed for some neural network layers. The image processing circuit can then select, for each neural network layer, a different subset of the input data (which can be immediate output data from a prior neural network layer) and a different subset of the weights to perform computations for that neural network layer. Such arrangements can provide finer granularity in leveraging the spatial sparsity and channel sparsity of neural network computations at each neural network layer, and for different neural network topologies, which in turn can further improve the accuracy and efficiency of the image processing operation. Specifically, in some examples, different layers of the image processing neural network may be configured, based on weights and/or topologies, to detect different sets of features of the target object from the input image. The features of the target object can be at different locations in the input data and associated with different channels for different neural network layers. Moreover, channel gating may be unsuitable for extraction of certain features that are associated with a full range of channels, as channel gating may decrease the accuracy of extraction of those features. Therefore, by using different spatial sparsity maps and different channel sparsity maps for different neural network layers, the image processing circuit can select the right subset of input data for each neural network layer, and for a particular neural network topology, which in turn can further improve the accuracy of the image processing operation.

In some examples, to reduce the memory data transfer involved in the generation of a spatial sparsity map and a channel sparsity map for a neural network layer, the image processing circuit can store both the intermediate output data from a previous neural network layer, as well as compressed intermediate output data, at the memory. The data sparsity map generation circuit can then fetch the compressed intermediate output data from the memory to generate the data sparsity map for the neural network layer, followed by the image processing circuit selectively fetching a subset of the intermediate output data from the memory based on the data sparsity map. Compared with a case where the data sparsity map generation circuit fetches the entirety of the intermediate output data of the previous neural network layer from the memory to generate the data sparsity map, such arrangements allow the data sparsity map generation circuit to fetch compressed intermediate output data from the memory, which can reduce the memory data transfer involved in the sparse image processing operation.

The image processing circuit can generate the compressed data using various techniques. In some examples, the image processing circuit can generate a channel tensor based on performing a pooling operation (e.g., average pooling, subsampling, etc.) among data elements of each group of data elements of an intermediate output tensor to generate groups of compressed data elements, and the groups of compressed data elements of the channel tensor can retrain the same pattern of channels as the intermediate output tensor. The image processing circuit can also generate a spatial tensor based on performing a pooling operation (e.g., average pooling, subsampling, etc.) between groups of data elements of different channels, and the spatial tensor can retain the number of data elements and patterns of features in a group as the intermediate output data, but have a reduced number of channels and groups. The data sparsity map generation circuit can generate the channel sparsity map based on the channel tensor of the previous network layer, and generate the spatial sparsity map based on the spatial tensor of the previous network layer.

In some examples, the data sparsity map generation circuit can generate the data sparsity map based on detecting patterns of features and/or channels in the input data. The data sparsity map generation circuit can use a machine learning model, such as a data sparsity map neural network, to learn about the patterns of features and channels in the input data to generate the data sparsity map. In some examples, the data sparsity map neural network may include a channel sparsity map neural network to generate a channel sparsity map from the channel tensor having groups/channels of compressed data elements, and a spatial sparsity map neural network to generate a spatial sparsity map from the spatial tensor having compressed channels. The channel sparsity map neural network may include multiple fully connected layers, while the spatial sparsity map neural network may include multiple convolution layers. The data sparsity map neural network may be trained using training data associated with reference/target outputs. The neural network can be trained to minimize differences between the outputs of the neural network and the reference/target outputs.

In some examples, the data sparsity map neural network can employ reparameterization trick and approximation techniques, such as Gumbel-Softmax Trick, to generate the data sparsity map. Specifically, the data sparsity map neural network can first generate, based on the input data, a set of soft masks for the channel sparsity map and the spatial sparsity map, with each soft mask having a range of values between 0 and 1 to indicate the probability of a channel (for a channel sparsity map) or a pixel (for a spatial sparsity map) being associated with an object of interest. An activation function, such as an arguments of the maxima (argmax) function, can be applied to the set of soft masks to generate a set of binary masks, with each binary mask having a binary value (e.g., 0 or 1) to select a channel or a pixel. But the activation function, such as argmax, may include a non-differentiable mathematical operation. This makes it challenging to implement the training operation that may include determining a loss gradient at the output layer to measure a rate of difference between the outputs and the references with respect to each data element of the outputs, and propagating the loss gradient back to the other layers to update the weights to reduce the differences between the outputs and the references. To overcome the challenge posted by the non-differentiability of the argmax activation function, the data sparsity map neural network can employ Gumbel-Softmax Trick to provide a differentiable approximation of argmax. As part of Gumbel-Softmax Trick, random numbers from a Gumbel distribution can be added to the soft masks as sampling noise, followed by applying a soft max function on the soft masks with the sampling noise to generate the binary masks. The soft masks can be used to compute the gradient of the output masks with respect to the weight during the backward propagation operation.

In some examples, the data map generation circuit and the image processing circuit can be implemented on a neural network hardware accelerator. The neural network hardware accelerator can include an on-chip local memory (e.g., static random-access memory (SRAM)), a computation engine, an output buffer, and a controller. The neural network hardware accelerator can also be connected to external circuits, such as a host and an external off-chip memory (e.g., dynamic random-access memory (DRAM)), via a bus. The on-chip local memory can store the input data and weights for a neural network layer. The computation engine can include an array of processing elements each including arithmetic circuits (e.g., multiplier, adder, etc.) to perform neural network computations for the neural network layer. The output buffer can provide temporary storage for the outputs of the computation engine. The output buffer can also include circuits to perform various post-processing operations, such as pooling, activation function processing, etc., on the outputs of the computation engine to generate the intermediate output data for the neural network layer.

To perform computations for a neural network layer, the controller can fetch input data and weights for the neural network layer from the external off-chip memory, and store the input data and weights at the on-chip local memory. The controller may also store an address table, which can be in the form of a translation lookaside buffer (TLB), that translates between addresses of the external off-chip memory and the on-chip local memory. The TLB allows the controller to determine read addresses of the input data and weights at the external off-chip memory and their write addresses at the on-chip local memory, to support the fetching of the input data and weights from the external off-chip memory to the on-chip local memory. The controller can then control the computation engine to fetch the input data and weights from the on-chip local memory to perform the computations. After the output buffer completes the post-processing of the outputs of the computation engine and generates the intermediate output data, the controller can store the intermediate output data back to external off-chip memory as inputs to the next neural network layer, or as the final outputs of the neural network.

The controller can use the computation engine to perform computations for the data sparsity map neural network to generate the data sparsity map, and then use the data sparsity map to selectively fetch subsets of input data and weights to the computation engine to perform computations for the image processing neural network for a sparse image processing operation. In some examples, the external off-chip memory may store a first set of weights of a data sparsity map neural network for each layer of an image processing neural network, a second set of weights for each layer of the image processing neural network, as well as uncompressed intermediate output data and the first and second compressed intermediate output data of the neural network layers for which the computations have been completed. The controller can fetch these data from external off-chip memory to support the sparse image processing operation.

Specifically, prior to performing computations for an image processing neural network layer, the controller can first fetch the first set of weights of a data sparsity map neural network, as well as first and second compressed intermediate output data of a prior image processing neural network layer, from the off-chip external memory. The controller can then control the computing engine to perform neural network computations using the first set of weights and the first and second compressed intermediate output data to generate, respectively, the spatial sparsity map and the channel sparsity map for the image processing neural network layer, and store the spatial sparsity map and the channel sparsity map at the local memory.

The controller can then combine the address table in the TLB with the spatial sparsity map and the channel sparsity map to generate read and write addresses to selectively fetch a subset of intermediate output data of the prior image processing neural network layer and a subset of the second set of weights of the current image processing neural network layer from the off-chip external memory to the local memory. In some examples, the controller can access the address table to access the read addresses of the second set of weights associated with different channels, and use the read addresses for weights associated with the channels selected in the channel sparsity map to fetch the subset of the second set of weights. In addition, the controller can also access the address table to access the read addresses of the intermediate output data of the prior image processing neural network layer, and use the read addresses for the intermediate output data elements selected in the spatial sparsity map and associated with the selected channels to fetch the subset of intermediate output data. The controller can also store a pre-determined inactive value, such as zero, for the remaining subsets of weights and intermediate output data that are not fetched in the local memory. The controller can then control the computation engine to fetch the weights and intermediate output data, including those that are fetched from the external memory and those that have zero values, from the local memory to perform computations of the current image processing neural network layer to generate new intermediate output data. The controller can also control the output buffer to perform pooling operations on the new intermediate output data to generate new compressed intermediate output data, and store the new uncompressed and compressed intermediate output data back to the external memory to support the data sparsity generation operation and sparse image processing operation for the next image processing neural network layer.

In some examples, the neural network hardware accelerator can be integrated within the same package as an array of pixel cells to form an image sensor, where the sparse image processing operation at the neural network hardware accelerator can be performed to support a sparse image sensing operation by the image sensor. For example, the neural network hardware accelerator can be part of a compute circuit of the image sensor. For an image capture by the array of pixel cells, the neural network hardware accelerator can perform a sparse image processing operation to detect an object of interest from the image, and determine a region of interest in a subsequent image to be captured by the array of pixel cells. The compute circuit can then selectively enable a subset of the array of pixel cells corresponding to the region of interest to capture the subsequent image as a sparse image. As another example, the neural network hardware accelerator can also provide the object detection result to an application (e.g., a VR/AR/MR application) in the host to allow the application to update output content, to provide an interactive user experience.

With the disclosed techniques, a sparse image processing operation can be performed on high resolution images using resource-intensive techniques, such as a deep neural network (DNN), which can improve the accuracy of the sparse image processing operation while reducing the computation and memory resources as well as the power consumption of the sparse image processing operation. This allows the sparse image processing operation to be performed on resource-constrained devices such as mobile devices. Moreover, by dynamically generating different channel sparsity maps and spatial sparsity maps for different neural network layers based on the input image to the neural network, and using a machine learning model to generate the sparsity maps, the sparsity maps can be adapted to different input images, different neural network layers, and different neural networks. All these can provide finer granularity in leveraging the spatial sparsity and channel sparsity of neural network computations at each neural network layer, and for different neural network topologies, which in turn can further improve the accuracy and efficiency of the sparse image processing operation.

The disclosed techniques may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some examples, artificial reality may also be associated with applications, products, accessories, services, or some combination thereof, that are used to, for example, create content in an artificial reality and/or are otherwise used in (e.g., perform activities) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

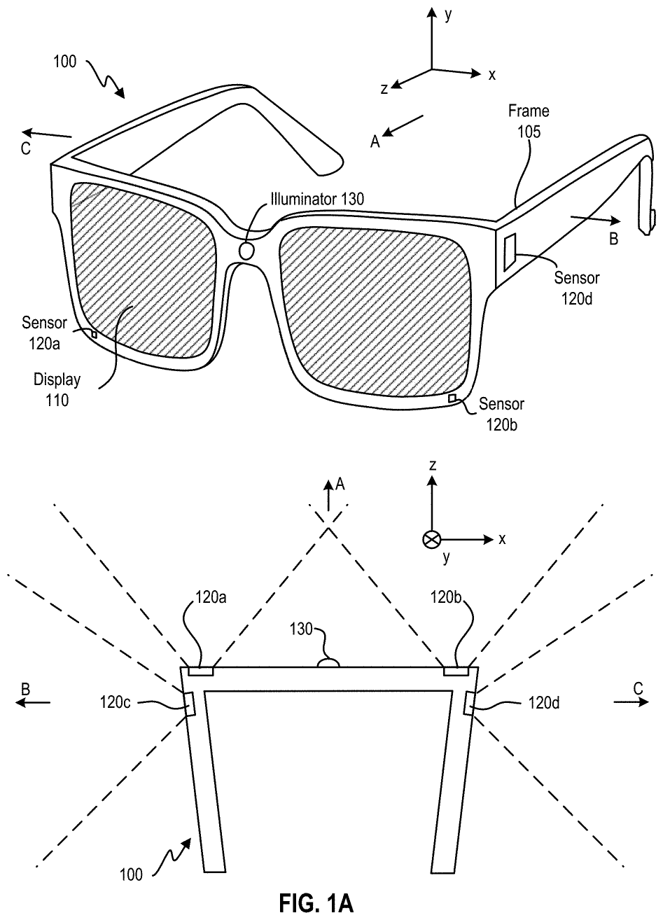

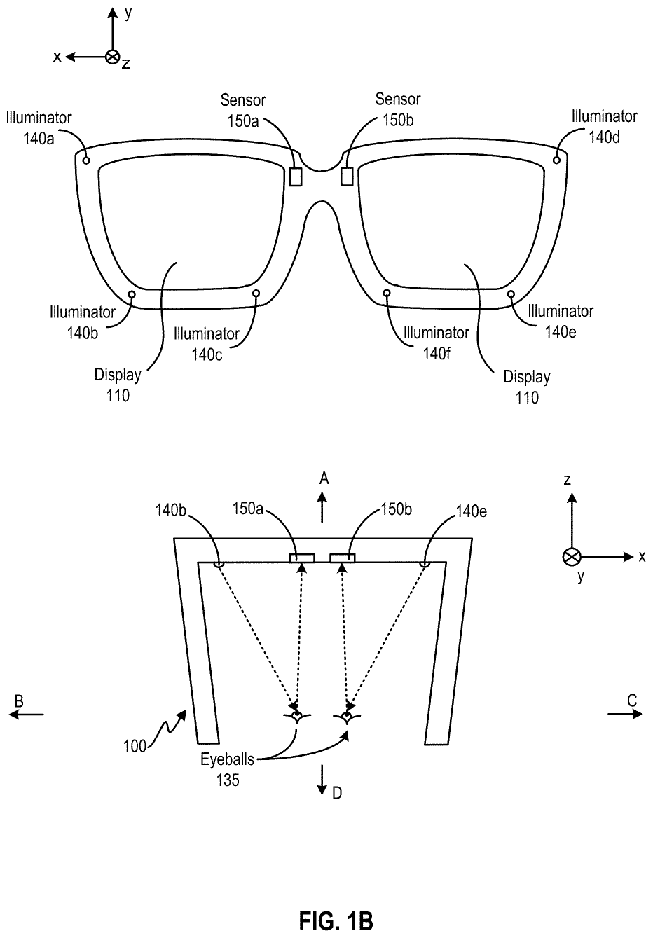

FIG. 1A is a diagram of an example of a near-eye display 100. Near-eye display 100 presents media to a user. Examples of media presented by near-eye display 100 include one or more images, video, and/or audio. In some examples, audio is presented via an external device (e.g., speakers and/or headphones) that receives audio information from the near-eye display 100, a console, or both, and presents audio data based on the audio information. Near-eye display 100 is generally configured to operate as a virtual reality (VR) display. In some examples, near-eye display 100 is modified to operate as an augmented reality (AR) display and/or a mixed reality (MR) display.

Near-eye display 100 includes a frame 105 and a display 110. Frame 105 is coupled to one or more optical elements. Display 110 is configured for the user to see content presented by near-eye display 100. In some examples, display 110 comprises a wave guide display assembly for directing light from one or more images to an eye of the user.

Near-eye display 100 further includes image sensors 120a, 120b, 120c, and 120d. Each of image sensors 120a, 120b, 120c, and 120d may include a pixel array configured to generate image data representing different fields of views along different directions. For example, sensors 120a and 120b may be configured to provide image data representing two fields of view towards a direction A along the Z axis, whereas sensor 120c may be configured to provide image data representing a field of view towards a direction B along the X axis, and sensor 120d may be configured to provide image data representing a field of view towards a direction C along the X axis.

In some examples, sensors 120a-120d can be configured as input devices to control or influence the display content of the near-eye display 100, to provide an interactive VR/AR/MR experience to a user who wears near-eye display 100. For example, sensors 120a-120d can generate physical image data of a physical environment in which the user is located. The physical image data can be provided to a location tracking system to track a location and/or a path of movement of the user in the physical environment. A system can then update the image data provided to display 110 based on, for example, the location and orientation of the user, to provide the interactive experience. In some examples, the location tracking system may operate a simultaneous localization and mapping (SLAM) algorithm to track a set of objects in the physical environment and within a field of view of the user as the user moves within the physical environment. The location tracking system can construct and update a map of the physical environment based on the set of objects, and track the location of the user within the map. By providing image data corresponding to multiple fields of view, sensors 120a-120d can provide the location tracking system with a more holistic view of the physical environment, which can lead to more objects included in the construction and updating of the map. With such an arrangement, the accuracy and robustness of tracking a location of the user within the physical environment can be improved.

In some examples, near-eye display 100 may further include one or more active illuminators 130 to project light into the physical environment. The light projected can be associated with different frequency spectrums (e.g., visible light, infrared (IR) light, ultraviolet light), and can serve various purposes. For example, illuminator 130 may project light in a dark environment (or in an environment with low intensity of (IR) light, ultraviolet light, etc.) to assist sensors 120a-120d in capturing images of different objects within the dark environment to, for example, enable location tracking of the user. Illuminator 130 may project certain markers onto the objects within the environment, to assist the location tracking system in identifying the objects for map construction/updating.

In some examples, illuminator 130 may also enable stereoscopic imaging. For example, one or more of sensors 120a or 120b can include both a first pixel array for visible light sensing and a second pixel array for (IR) light sensing. The first pixel array can be overlaid with a color filter (e.g., a Bayer filter), with each pixel of the first pixel array being configured to measure intensity of light associated with a particular color (e.g., one of red, green or blue (RGB) colors). The second pixel array (for IR light sensing) can also be overlaid with a filter that allows only IR light through, with each pixel of the second pixel array being configured to measure intensity of IR lights. The pixel arrays can generate an RGB image and an IR image of an object, with each pixel of the IR image being mapped to each pixel of the RGB image. Illuminator 130 may project a set of IR markers on the object, the images of which can be captured by the IR pixel array. Based on a distribution of the IR markers of the object as shown in the image, the system can estimate a distance of different parts of the object from the IR pixel array and generate a stereoscopic image of the object based on the distances. Based on the stereoscopic image of the object, the system can determine, for example, a relative position of the object with respect to the user, and can update the image data provided to display 100 based on the relative position information to provide the interactive experience.

As discussed above, near-eye display 100 may be operated in environments associated with a wide range of light intensities. For example, near-eye display 100 may be operated in an indoor environment or in an outdoor environment, and/or at different times of the day. Near-eye display 100 may also operate with or without active illuminator 130 being turned on. As a result, image sensors 120a-120d may need to have a wide dynamic range to be able to operate properly (e.g., to generate an output that correlates with the intensity of incident light) across a very wide range of light intensities associated with different operating environments for near-eye display 100.

FIG. 1B is a diagram of another example of near-eye display 100. FIG. 1B illustrates a side of near-eye display 100 that faces the eyeball(s) 135 of the user who wears near-eye display 100. As shown in FIG. 1B, near-eye display 100 may further include a plurality of illuminators 140a, 140b, 140c, 140d, 140e, and 140f. Near-eye display 100 further includes a plurality of image sensors 150a and 150b. Illuminators 140a, 140b, and 140c may emit lights of certain frequency range (e.g., near-infra red (NIR)) towards direction D (which is opposite to direction A of FIG. 1A). The emitted light may be associated with a certain pattern, and can be reflected by the left eyeball of the user. Sensor 150a may include a pixel array to receive the reflected light and generate an image of the reflected pattern. Similarly, illuminators 140d, 140e, and 140f may emit NIR lights carrying the pattern. The NIR lights can be reflected by the right eyeball of the user, and may be received by sensor 150b. Sensor 150b may also include a pixel array to generate an image of the reflected pattern. Based on the images of the reflected pattern from sensors 150a and 150b, the system can determine a gaze point of the user and update the image data provided to display 100 based on the determined gaze point to provide an interactive experience to the user.

As discussed above, to avoid damaging the eyeballs of the user, illuminators 140a, 140b, 140c, 140d, 140e, and 140f are typically configured to output lights of low intensities. In a case where image sensors 150a and 150b comprise the same sensor devices as image sensors 120a-120d of FIG. 1A, the image sensors 120a-120d may need to be able to generate an output that correlates with the intensity of incident light when the intensity of the incident light is low, which may further increase the dynamic range requirement of the image sensors.

Moreover, the image sensors 120a-120d may need to be able to generate an output at a high speed to track the movements of the eyeballs. For example, a user's eyeball can perform a very rapid movement (e.g., a saccade movement) in which there can be a quick jump from one eyeball position to another. To track the rapid movement of the user's eyeball, image sensors 120a-120d need to generate images of the eyeball at high speed. For example, the rate at which the image sensors generate an image (the frame rate) needs to at least match the speed of movement of the eyeball. The high frame rate requires short total exposure time for all of the pixel cells involved in generating the image, as well as high speed for converting the sensor outputs into digital values for image generation. Moreover, as discussed above, the image sensors also need to be able to operate at an environment with low light intensity.

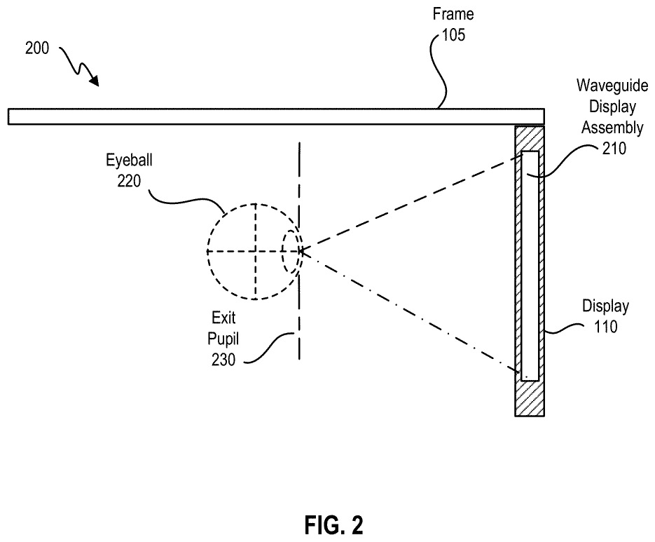

FIG. 2 is an example of a cross section 200 of near-eye display 100 illustrated in FIG. 1A and FIG. 1B. Display 110 includes at least one waveguide display assembly 210. An exit pupil 230 is a location where a single eyeball 220 of the user is positioned in an eyebox region when the user wears the near-eye display 100. For purposes of illustration, FIG. 2 shows the cross section 200 associated with eyeball 220 and a single waveguide display assembly 210, but a second waveguide display is used for a second eye of a user.

Waveguide display assembly 210 is configured to direct image light to an eyebox located at exit pupil 230 and to eyeball 220. Waveguide display assembly 210 may be composed of one or more materials (e.g., plastic, glass) with one or more refractive indices. In some examples, near-eye display 100 includes one or more optical elements between waveguide display assembly 210 and eyeball 220.

In some examples, waveguide display assembly 210 includes a stack of one or more waveguide displays including, but not restricted to, a stacked waveguide display, a varifocal waveguide display, etc. The stacked waveguide display is a polychromatic display (e.g., a RGB display) created by stacking waveguide displays whose respective monochromatic sources are of different colors. The stacked waveguide display is also a polychromatic display that can be projected on multiple planes (e.g., multiplanar colored display). In some configurations, the stacked waveguide display is a monochromatic display that can be projected on multiple planes (e.g., multiplanar monochromatic display). The varifocal waveguide display is a display that can adjust a focal position of image light emitted from the waveguide display. In alternate examples, waveguide display assembly 210 may include the stacked waveguide display and the varifocal waveguide display.

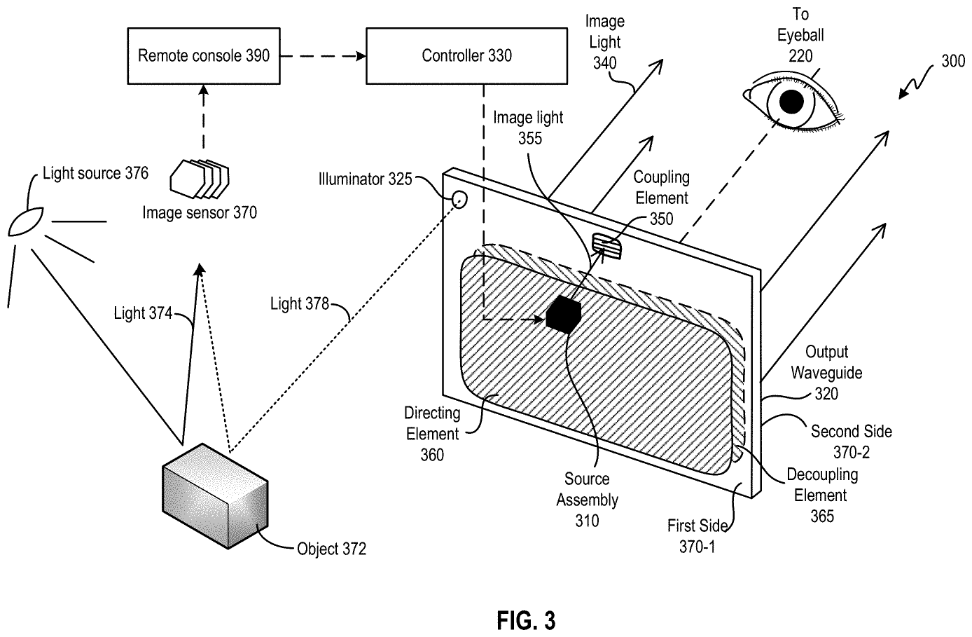

FIG. 3 illustrates an isometric view of an example of a waveguide display 300. In some examples, waveguide display 300 is a component (e.g., waveguide display assembly 210) of near-eye display 100. In some examples, waveguide display 300 is part of some other near-eye display or other system that directs image light to a particular location.

Waveguide display 300 includes a source assembly 310, an output waveguide 320, and a controller 330. For purposes of illustration, FIG. 3 shows the waveguide display 300 associated with a single eyeball 220, but in some examples, another waveguide display separate, or partially separate, from the waveguide display 300 provides image light to another eye of the user.

Source assembly 310 generates image light 355. Source assembly 310 generates and outputs image light 355 to a coupling element 350 located on a first side 370-1 of output waveguide 320. Output waveguide 320 is an optical waveguide that outputs expanded image light 340 to an eyeball 220 of a user. Output waveguide 320 receives image light 355 at one or more coupling elements 350 located on the first side 370-1 and guides received input image light 355 to a directing element 360. In some examples, coupling element 350 couples the image light 355 from source assembly 310 into output waveguide 320. Coupling element 350 may be, e.g., a diffraction grating, a holographic grating, one or more cascaded reflectors, one or more prismatic surface elements, and/or an array of holographic reflectors.

Directing element 360 redirects the received input image light 355 to decoupling element 365 such that the received input image light 355 is decoupled out of output waveguide 320 via decoupling element 365. Directing element 360 is part of, or affixed to, the first side 370-1 of output waveguide 320. Decoupling element 365 is part of, or affixed to, the second side 370-2 of output waveguide 320, such that directing element 360 is opposed to the decoupling element 365. Directing element 360 and/or decoupling element 365 may be, e.g., a diffraction grating, a holographic grating, one or more cascaded reflectors, one or more prismatic surface elements, and/or an array of holographic reflectors.

Second side 370-2 represents a plane along an x-dimension and a y-dimension. Output waveguide 320 may be composed of one or more materials that facilitate total internal reflection of image light 355. Output waveguide 320 may be composed of e.g., silicon, plastic, glass, and/or polymers. Output waveguide 320 has a relatively small form factor. For example, output waveguide 320 may be approximately 50 mm wide along x-dimension, 30 mm long along y-dimension and 0.5-1 mm thick along a z-dimension.

Controller 330 controls scanning operations of source assembly 310. The controller 330 determines scanning instructions for the source assembly 310. In some examples, the output waveguide 320 outputs expanded image light 340 to the user's eyeball 220 with a large field of view (FOV). For example, the expanded image light 340 is provided to the user's eyeball 220 with a diagonal FOV (in x and y) of 60 degrees and/or greater and/or 150 degrees and/or less. The output waveguide 320 is configured to provide an eyebox with a length of 20 mm or greater and/or equal to or less than 50 mm; and/or a width of 10 mm or greater and/or equal to or less than 50 mm.

Moreover, controller 330 also controls image light 355 generated by source assembly 310, based on image data provided by image sensor 370. Image sensor 370 may be located on first side 370-1 and may include, for example, image sensors 120a-120d of FIG. 1A. Image sensors 120a-120d can be operated to perform 2D sensing and 3D sensing of, for example, an object 372 in front of the user (e.g., facing first side 370-1). For 2D sensing, each pixel cell of image sensors 120a-120d can be operated to generate pixel data representing an intensity of light 374 generated by a light source 376 and reflected off object 372. For 3D sensing, each pixel cell of image sensors 120a-120d can be operated to generate pixel data representing a time-of-flight measurement for light 378 generated by illuminator 325. For example, each pixel cell of image sensors 120a-120d can determine a first time when illuminator 325 is enabled to project light 378 and a second time when the pixel cell detects light 378 reflected off object 372. The difference between the first time and the second time can indicate the time-of-flight of light 378 between image sensors 120a-120d and object 372, and the time-of-flight information can be used to determine a distance between image sensors 120a-120d and object 372. Image sensors 120a-120d can be operated to perform 2D and 3D sensing at different times, and provide the 2D and 3D image data to a remote console 390 that may be (or may be not) located within waveguide display 300. The remote console may combine the 2D and 3D images to, for example, generate a 3D model of the environment in which the user is located, to track a location and/or orientation of the user, etc. The remote console may determine the content of the images to be displayed to the user based on the information derived from the 2D and 3D images. The remote console can transmit instructions to controller 330 related to the determined content. Based on the instructions, controller 330 can control the generation and outputting of image light 355 by source assembly 310, to provide an interactive experience to the user.

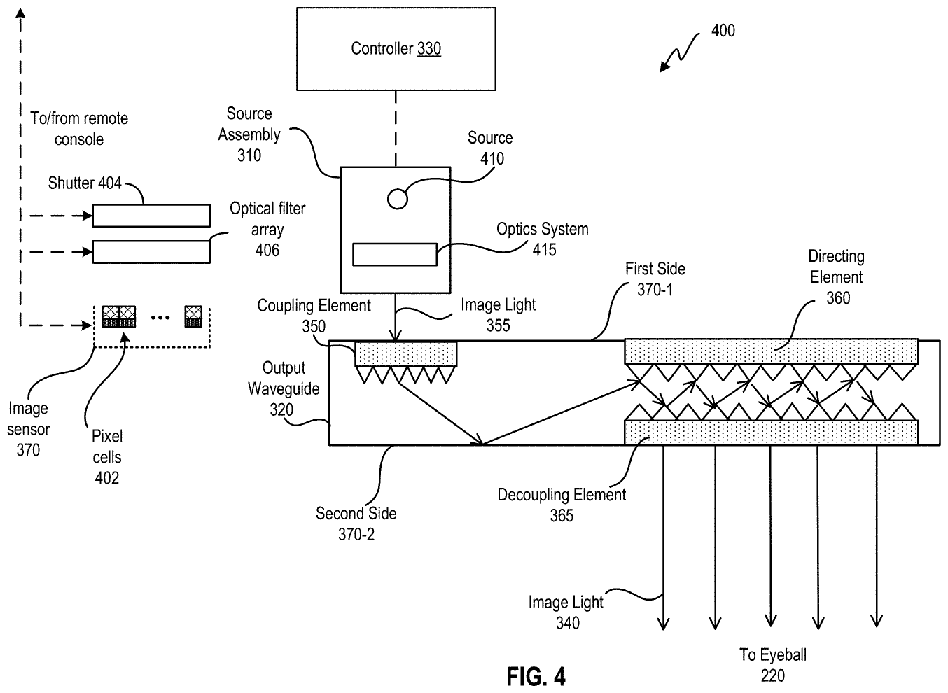

FIG. 4 illustrates an example of a cross section 400 of the waveguide display 300. The cross section 400 includes source assembly 310, output waveguide 320, and image sensor 370. In the example of FIG. 4, image sensor 370 may include a set of pixel cells 402 located on first side 370-1 to generate an image of the physical environment in front of the user. In some examples, there can be a mechanical shutter 404 and an optical filter array 406 interposed between the set of pixel cells 402 and the physical environment. Mechanical shutter 404 can control the exposure of the set of pixel cells 402. In some examples, the mechanical shutter 404 can be replaced by an electronic shutter gate, such as in a global shutter or rolling shutter configuration, as to be discussed below. Optical filter array 406 can control an optical wavelength range of light the set of pixel cells 402 is exposed to, as to be discussed below. Each of pixel cells 402 may correspond to one pixel of the image. Although not shown in FIG. 4, it is understood that each of pixel cells 402 may also be overlaid with a filter to control the optical wavelength range of the light to be sensed by the pixel cells.

After receiving instructions from the remote console, mechanical shutter 404 can open and expose the set of pixel cells 402 in an exposure period. During the exposure period, image sensor 370 can obtain samples of lights incident on the set of pixel cells 402, and generate image data based on an intensity distribution of the incident light samples detected by the set of pixel cells 402. Image sensor 370 can then provide the image data to the remote console, which determines the display content, and provide the display content information to controller 330. Controller 330 can then determine image light 355 based on the display content information.

Source assembly 310 generates image light 355 in accordance with instructions from the controller 330. Source assembly 310 includes a source 410 and an optics system 415. Source 410 is a light source that generates coherent or partially coherent light. Source 410 may be, e.g., a laser diode, a vertical cavity surface emitting laser, and/or a light emitting diode.

Optics system 415 includes one or more optical components that condition the light from source 410. Conditioning light from source 410 may include, e.g., expanding, collimating, and/or adjusting orientation in accordance with instructions from controller 330. The one or more optical components may include one or more lenses, liquid lenses, mirrors, apertures, and/or gratings. In some examples, optics system 415 includes a liquid lens with a plurality of electrodes that allows scanning of a beam of light with a threshold value of scanning angle to shift the beam of light to a region outside the liquid lens. Light emitted from the optics system 415 (and also source assembly 310) is referred to as image light 355.

Output waveguide 320 receives image light 355. Coupling element 350 couples image light 355 from source assembly 310 into output waveguide 320. In examples where coupling element 350 is a diffraction grating, a pitch of the diffraction grating is chosen such that total internal reflection occurs in output waveguide 320 and image light 355 propagates internally in output waveguide 320 (e.g., by total internal reflection) toward decoupling element 365.

Directing element 360 redirects image light 355 toward decoupling element 365 for decoupling from output waveguide 320. In examples where directing element 360 is a diffraction grating, the pitch of the diffraction grating is chosen to cause incident image light 355 to exit output waveguide 320 at angle(s) of inclination relative to a surface of decoupling element 365.

In some examples, directing element 360 and/or decoupling element 365 are structurally similar. Expanded image light 340 exiting output waveguide 320 is expanded along one or more dimensions (e.g., may be elongated along x-dimension). In some examples, waveguide display 300 includes a plurality of source assemblies 310 and a plurality of output waveguides 320. Each of source assemblies 310 emits a monochromatic image light of a specific band of wavelength corresponding to a primary color (e.g., red, green, or blue). Each of output waveguides 320 may be stacked together with a distance of separation to output an expanded image light 340 that is multi-colored.

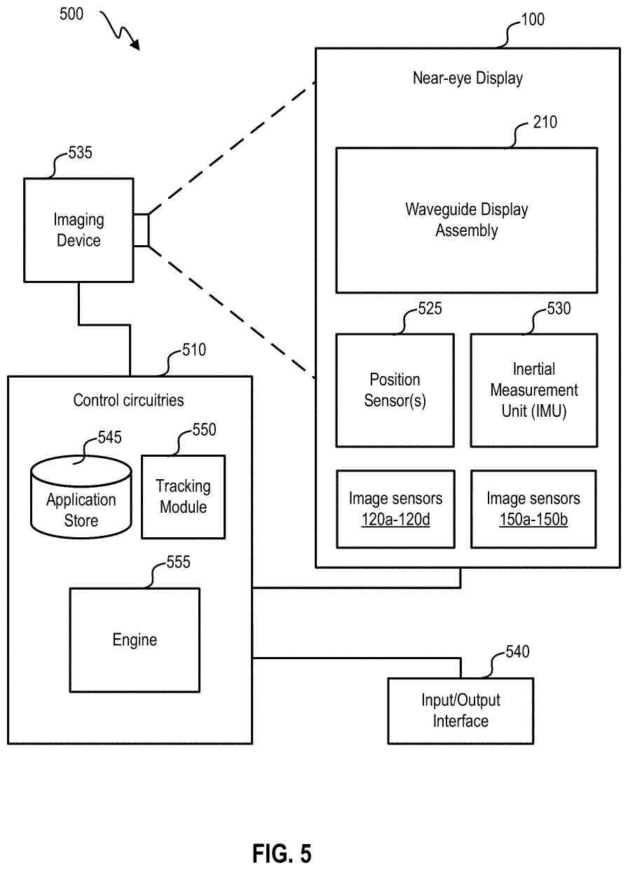

FIG. 5 is a block diagram of an example of a system 500 including the near-eye display 100. The system 500 comprises near-eye display 100, an imaging device 535, an input/output interface 540, and image sensors 120a-120d and 150a-150b that are each coupled to control circuitries 510. System 500 can be configured as a head-mounted device, a mobile device, a wearable device, etc.

Near-eye display 100 is a display that presents media to a user. Examples of media presented by the near-eye display 100 include one or more images, video, and/or audio. In some examples, audio is presented via an external device (e.g., speakers and/or headphones) that receives audio information from near-eye display 100 and/or control circuitries 510 and presents audio data based on the audio information to a user. In some examples, near-eye display 100 may also act as an AR eyewear glass. In some examples, near-eye display 100 augments views of a physical, real-world environment with computer-generated elements (e.g., images, video, sound).

Near-eye display 100 includes waveguide display assembly 210, one or more position sensors 525, and/or an inertial measurement unit (IMU) 530. Waveguide display assembly 210 includes source assembly 310, output waveguide 320, and controller 330.

IMU 530 is an electronic device that generates fast calibration data indicating an estimated position of near-eye display 100 relative to an initial position of near-eye display 100 based on measurement signals received from one or more of position sensors 525.

Imaging device 535 may generate image data for various applications. For example, imaging device 535 may generate image data to provide slow calibration data in accordance with calibration parameters received from control circuitries 510. Imaging device 535 may include, for example, image sensors 120a-120d of FIG. 1A for generating image data of a physical environment in which the user is located for performing location tracking of the user. Imaging device 535 may further include, for example, image sensors 150a-150b of FIG. 1B for generating image data for determining a gaze point of the user to identify an object of interest of the user.

The input/output interface 540 is a device that allows a user to send action requests to the control circuitries 510. An action request is a request to perform a particular action. For example, an action request may be to start or end an application or to perform a particular action within the application.

Control circuitries 510 provide media to near-eye display 100 for presentation to the user in accordance with information received from one or more of: imaging device 535, near-eye display 100, and/or input/output interface 540. In some examples, control circuitries 510 can be housed within system 500 configured as a head-mounted device. In some examples, control circuitries 510 can be a standalone console device communicatively coupled with other components of system 500. In the example shown in FIG. 5, control circuitries 510 include an application store 545, a tracking module 550, and an engine 555.

The application store 545 stores one or more applications for execution by the control circuitries 510. An application is a group of instructions that, when executed by a processor, generates content for presentation to the user. Examples of applications include gaming applications, conferencing applications, video playback applications, or other suitable applications.

Tracking module 550 calibrates system 500 using one or more calibration parameters and may adjust one or more calibration parameters to reduce error in determination of the position of the near-eye display 100.

Tracking module 550 tracks movements of near-eye display 100 using slow calibration information from the imaging device 535. Tracking module 550 also determines positions of a reference point of near-eye display 100 using position information from the fast calibration information.

Engine 555 executes applications within system 500 and receives position information, acceleration information, velocity information, and/or predicted future positions of near-eye display 100 from tracking module 550. In some examples, information received by engine 555 may be used for producing a signal (e.g., display instructions) to waveguide display assembly 210 that determines a type of content presented to the user. For example, to provide an interactive experience, engine 555 may determine the content to be presented to the user based on a location of the user (e.g., provided by tracking module 550), or a gaze point of the user (e.g., based on image data provided by imaging device 535), or a distance between an object and user (e.g., based on image data provided by imaging device 535).

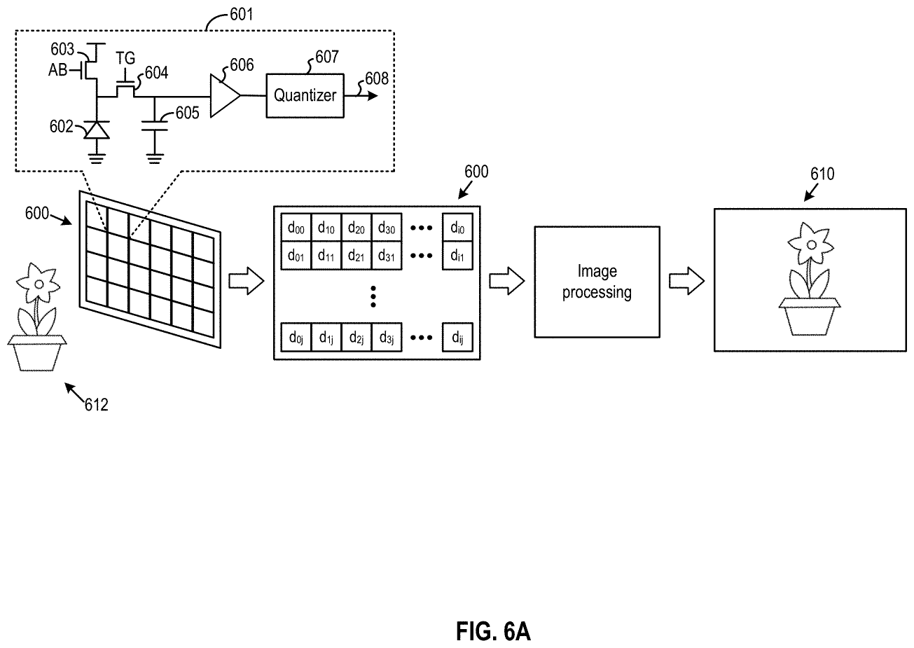

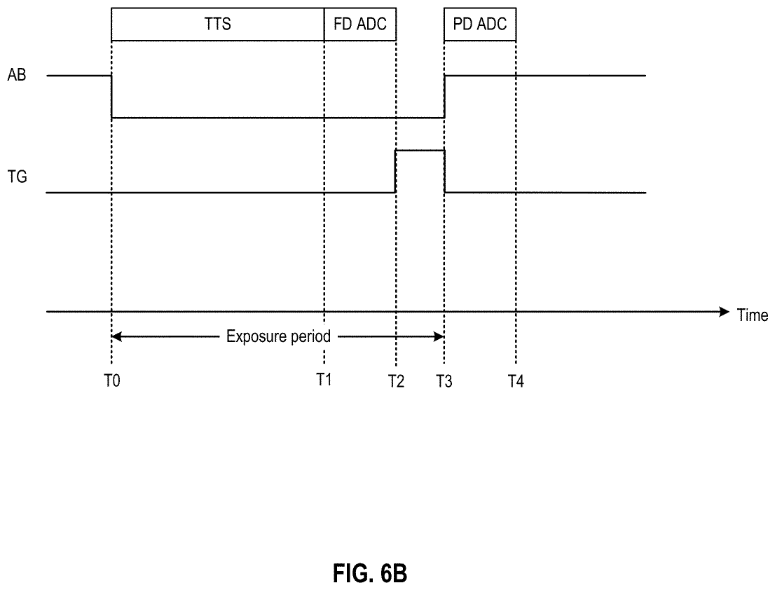

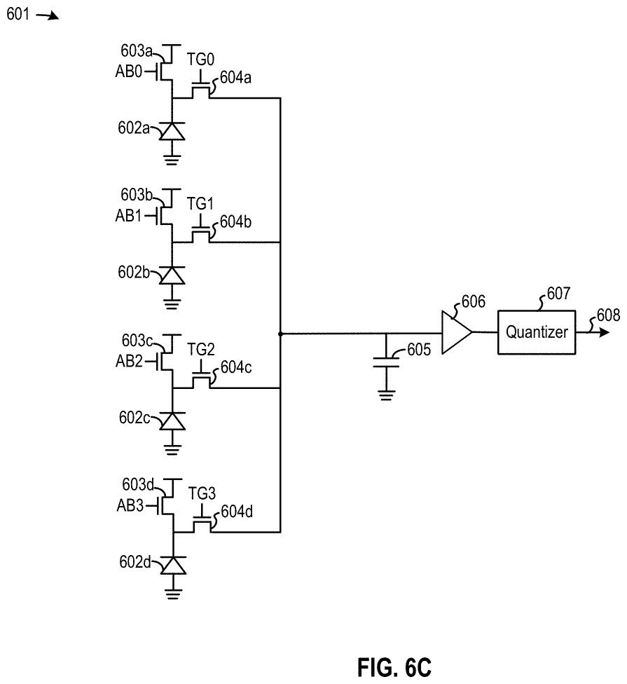

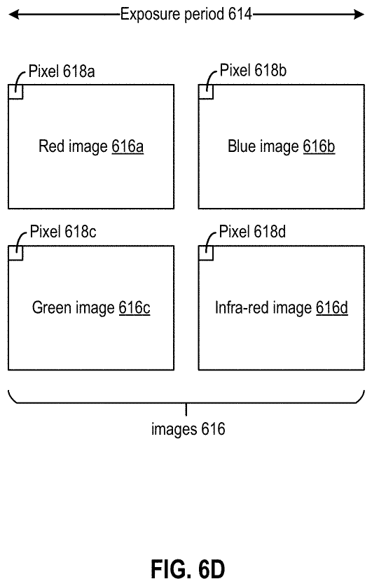

FIG. 6A, FIG. 6B, FIG. 6C, and FIG. 6D illustrate examples of an image sensor 600 and its operations. As shown in FIG. 6A, image sensor 600 can include an array of pixel cells, including pixel cell 601, and can generate digital intensity data corresponding to pixels of an image. Pixel cell 601 may be part of pixel cells 402 of FIG. 4 and can also be part of sensors 120 and 150 of FIG. 1A and FIG. 1B. As shown in FIG. 6A, pixel cell 601 may include a photodiode 602, an electronic shutter switch 603, a transfer switch 604, a charge storage device 605, a buffer 606, and a quantizer 607. Photodiode 602 may include, for example, a P-N diode, a P-I-N diode, a pinned diode, etc., whereas charge storage device 605 can be a floating diffusion node of transfer switch 604. Photodiode 602 can generate and accumulate residual charge upon receiving light within an exposure period. Upon saturation by the residual charge within the exposure period, photodiode 602 can output overflow charge to charge storage device 605 via transfer switch 604. Charge storage device 605 can convert the overflow charge to a voltage, which can be buffered by buffer 606. The buffered voltage can be quantized by quantizer 607 to generate measurement data 608 to represent, for example, the intensity of light received by photodiode 602 within the exposure period. An image 610 of an object 612 imaged by image sensor 600 can then be generated.

Quantizer 607 may include a comparator to compare the buffered voltage with different thresholds for different quantization operations associated with different intensity ranges. For example, for a high intensity range where the quantity of overflow charge generated by photodiode 602 exceeds a saturation limit of charge storage device 605, quantizer 607 can perform a time-to-saturation (TTS) measurement operation by detecting whether the buffered voltage exceeds a static threshold representing the saturation limit, and if it does, measuring the time it takes for the buffered voltage to exceed the static threshold. The measured time can be inversely proportional to the light intensity. Also, for a medium intensity range in which the photodiode is saturated by the residual charge, but the overflow charge remains below the saturation limit of charge storage device 605, quantizer 607 can perform a fully digital analog to digital converter (FD ADC) operation to measure a quantity of the overflow charge stored in charge storage device 605. Further, for a low intensity range in which the photodiode is not saturated by the residual charge and no overflow charge is accumulated in charge storage device 605, quantizer 607 can perform a digital process meter for analog sensors (PD ADC) operation to measure a quantity of the residual charge accumulated in photodiode 602. The output of one of the TTS, FD ADC, or PD ADC operations can be output as measurement data 608 to represent the intensity of light.

FIG. 6B illustrates an example sequence of operations of pixel cell 601. As shown in FIG. 6B, the exposure period can be defined based on the timing of AB signal controlling electronic shutter switch 603, which can steer the charge generated by photodiode 602 away when enabled, and based on the timing of the TG signal controlling transfer switch 604, which can be controlled to transfer the overflow charge and then the residual charge to charge storage device 605 for read-out. For example, referring to FIG. 6B, the AB signal can be de-asserted at time T0 to allow photodiode 602 to generate charge. T0 can mark the start of the exposure period. Within the exposure period, the TG signal can set transfer switch 604 at a partially-on state to allow photodiode 602 to accumulate at least some of the charge as residual charge until photodiode 602 saturates, after which overflow charge can be transferred to charge storage device 605. Between times T0 and T1, quantizer 607 can perform a TTS operation to determine whether the overflow charge at charge storage device 605 exceeds the saturation limit, and then between times T1 and T2, quantizer 607 can perform a FD ADC operation to measure a quantity of the overflow charge at charge storage device 605. Between times T2 and T3, the TG signal can be asserted to bias transfer switch 604 in a fully-on state to transfer the residual charge to charge storage device 605. At time T3, the TG signal can be de-asserted to isolate charge storage device 605 from photodiode 602, whereas the AB signal can be asserted to steer the charge generated by photodiode 602 away. The time T3 can mark the end of the exposure period. Between times T3 and T4, quantizer 607 can perform a PD operation to measure a quantity of the residual charge.

The AB and TG signals can be generated by a controller (not shown in FIG. 6A) which can be part of pixel cell 601 to control the duration of the exposure period and the sequence of quantization operations. The controller can also detect whether charge storage device 605 is saturated and whether photodiode 602 is saturated to select the outputs from one of the TTS, FD ADC, or PD ADC operations as measurement data 608. For example, if charge storage device 605 is saturated, the controller can provide the TTS output as measurement data 608. If charge storage device 605 is not saturated but photodiode 602 is saturated, the controller can provide the FD ADC output as measurement data 608. If photodiode 602 is not saturated, the controller can provide the PD ADC output as measurement data 608. The measurement data 608 from each of the pixel cells of image sensor 600 generated within the exposure period can form an image. The controller can repeat the sequence of operations in FIG. 6B in subsequent exposure periods to generate subsequent images.

Although FIG. 6A illustrates that a pixel cell 601 includes a photodiode 602, pixel cell 601 can also include multiple photodiodes, with each photodiode configured to sense light of different wavelength ranges. FIG. 6C illustrates another example of pixel cell 601 including multiple photodiodes 602a, 602b, 602c, and 602d, each of which has a corresponding electronic shutter switch (one of shutter switches 603a-d) and a corresponding transfer switch (one of transfer switches 604a-d). Photodiode 602a can be configured to sense light of a visible red wavelength range (e.g., 622 nm-780 nm), photodiode 602b can be configured to sense light of a visible green wavelength range (e.g., 492 nm-577 nm), photodiode 602c can be configured to sense light of a visible blue wavelength range (e.g., 455 nm-492 nm), whereas photodiode 602d can be configured to sense light of an infra-red wavelength range (e.g., 780 nm-1 mm). Each of these wavelength ranges can correspond to a channel. The photodiodes can be enabled to sense light and generate charge within the same exposure period shown in FIG. 6B based on the timing of the AB0, AB1, AB2, and AB3 signals. Each photodiode can then take turns in transferring the charge-to-charge storage device 605, followed by quantizer 607 quantizing the charge to generate measurement data 608 for each channel, based on the timing of the TG0, TG1, TG2, and TG3 signals.

An image sensor 600 having an array of multi-photodiode pixel cells 601 can generate, based on light received with an exposure period, multiple images, each corresponding to a channel. For example, referring to FIG. 6D, based on light detected within exposure period 614, image sensor 600 can generate images 616 including a red image 616a, a blue image 616b, a green image 616c, and an infra-red image 616d. Corresponding pixels 618a, 618b, 618c, and 618d of images 616a-616d can be generated based on outputs of photodiodes 602a-d of the same pixel cell.

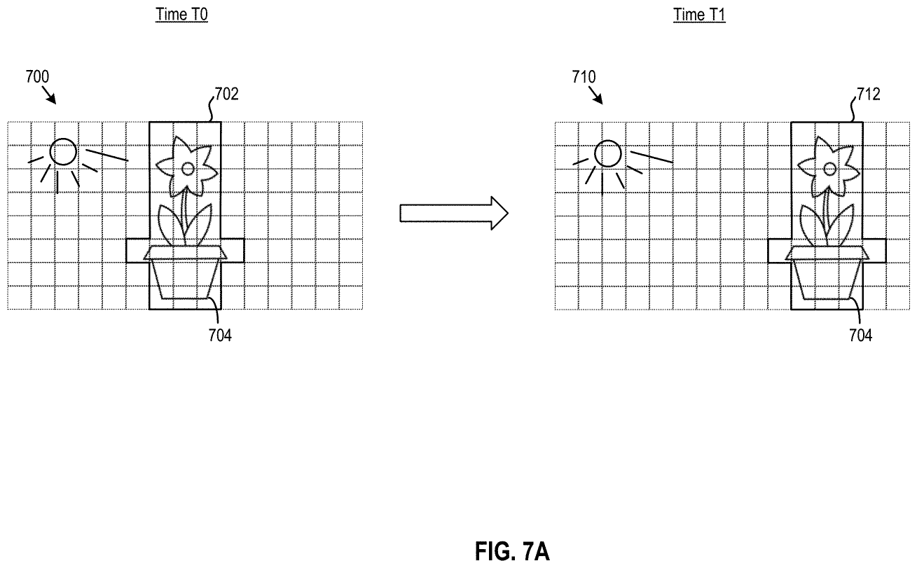

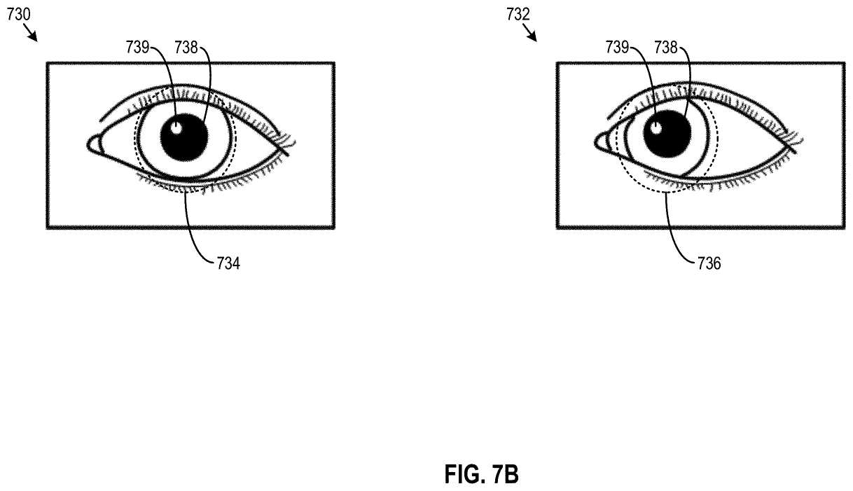

The image data from image sensor 600 can be processed to support different applications, such as tracking one or more objects, detecting a motion (e.g., as part of a dynamic vision sensing (DVS) operation), etc. FIG. 7A and FIG. 7B illustrate examples of applications that can be supported by the image data from image sensor 600. FIG. 7A illustrates an example of an object-tracking operation based on images from image sensor 600. As shown in FIG. 7A, based on an image processing operation, a group of pixels in a region of interest (ROI) 702 corresponding to object 704 can be identified from an image 700 captured at time T0. An application can then track the location of object 704 in subsequent images, including image 710 captured at time T1, based on the image processing operation results. The application can identify group of pixels in ROI 712 corresponding to object 704. The tracking of the image location of object 704 within an image can be performed to support a SLAM algorithm, which can construct/update a map of an environment in which image sensor 600 (and a mobile device that includes image sensor 600, such as near-eye display 100) is situated, based on tracking the image location of object 704 in a scene captured by image sensor 600.

FIG. 7B illustrates an example of an eye-tracking operation on images from image sensor 600. In some examples, referring back to FIG. 1B, an illuminator (e.g., illuminators 140a-140f) can project infra-red light into an eyeball, and the reflected infra-red light can be detected by image sensor 600. Referring to FIG. 7B, based on an image processing operation on images 730 and 732 of an eyeball, groups of pixels 734 and 736 corresponding to a pupil 738 and a glint 739 can be identified. The identification of pupil 738 and glint 739 can be performed to support the eye-tracking operation. For example, based on the image locations of pupil 738 and glint 739, the application can determine the gaze directions of the user at different times, which can be provided as inputs to the system to determine, for example, the content to be displayed to the user.

In both FIG. 7A and FIG. 7B, an image processing operation can be performed by an image processor on the images to detect an object of interest/target object, such as object 704 of FIG. 7A, an eyeball of FIG. 7B, etc., and their locations in the images. The detection of the target object can be based on detection of a pattern of features of the target object from the images. A feature can be represented by, for example, a pattern of light intensities for different wavelength ranges. For example, in FIG. 7A, object 704 can be identified by features associated with different colors, whereas in FIG. 7B, the eyeball can be identified by a pattern of intensities of reflected infra-red light.

One way to extract/identify features from images is by performing a convolution operation. As part of the convolution operation, a filter tensor representing the features to be detected can traverse through and superimpose with a data tensor representing an image in multiple strides. For each stride, a sum of multiplications between the weight tensor and the superimposed portions of the input data tensor can be generated as an output of the convolution operation, and multiple outputs of the convolution operation can be generated at the multiple strides. The sum of multiplications at a stride location can indicate, for example, a likelihood of the features represented by the filter tensor being found at the stride location of the image.

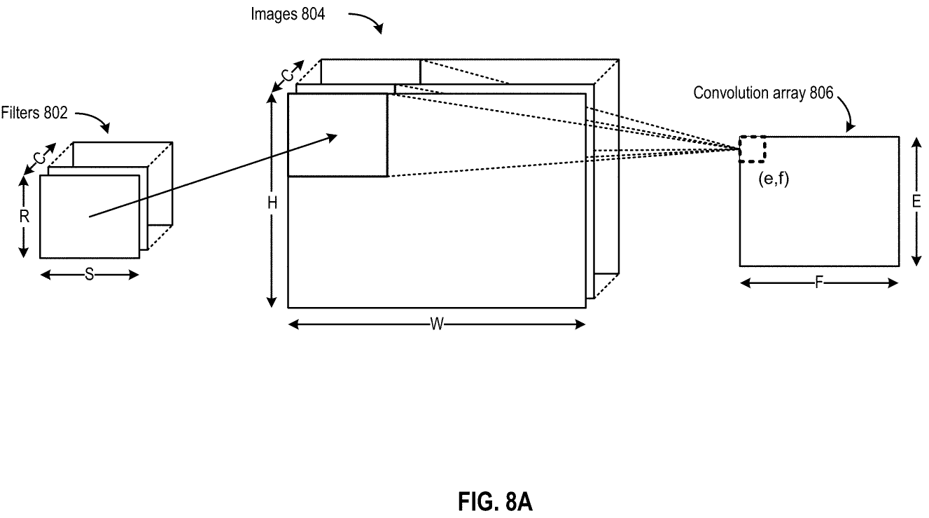

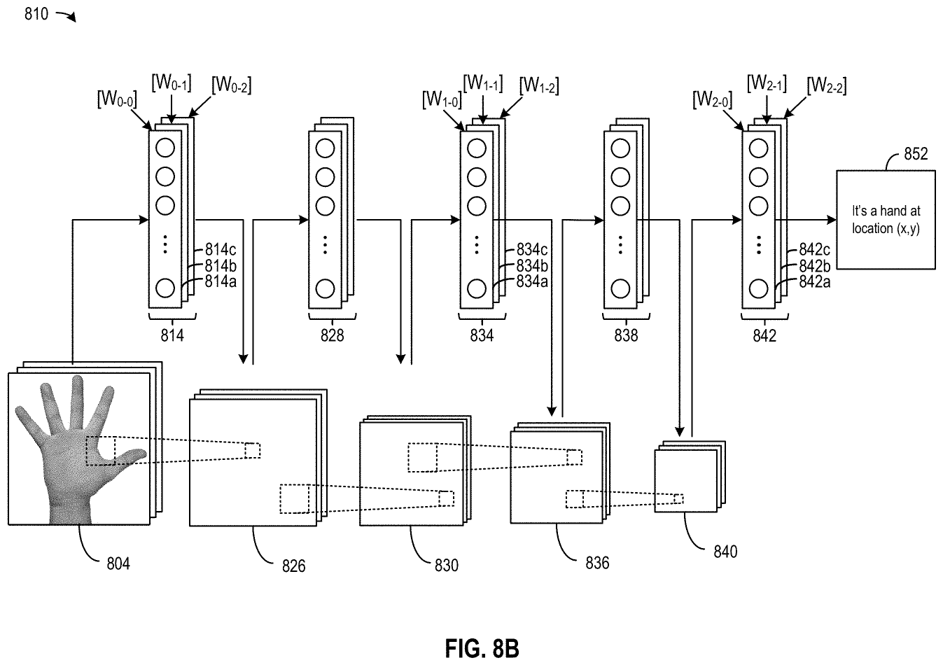

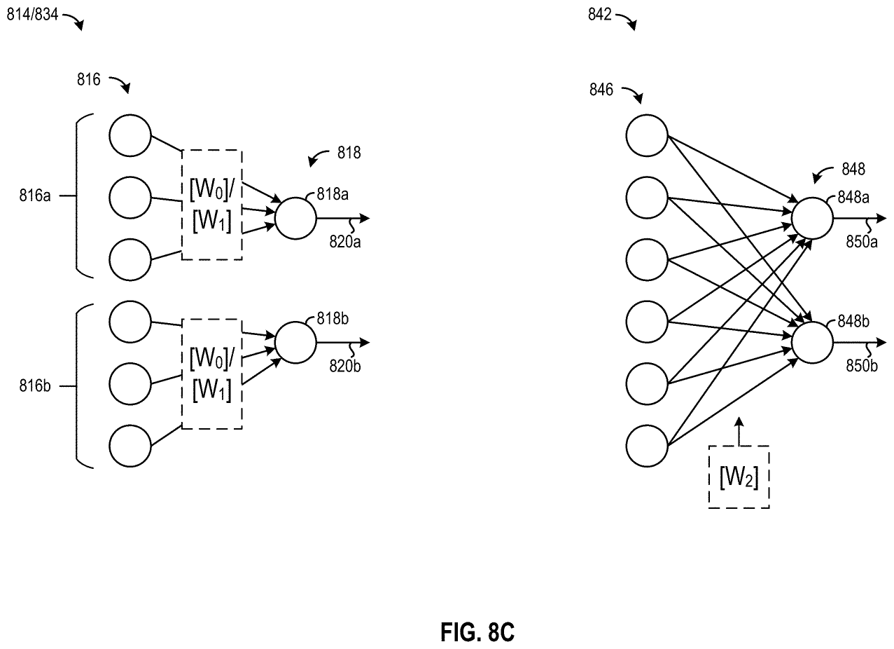

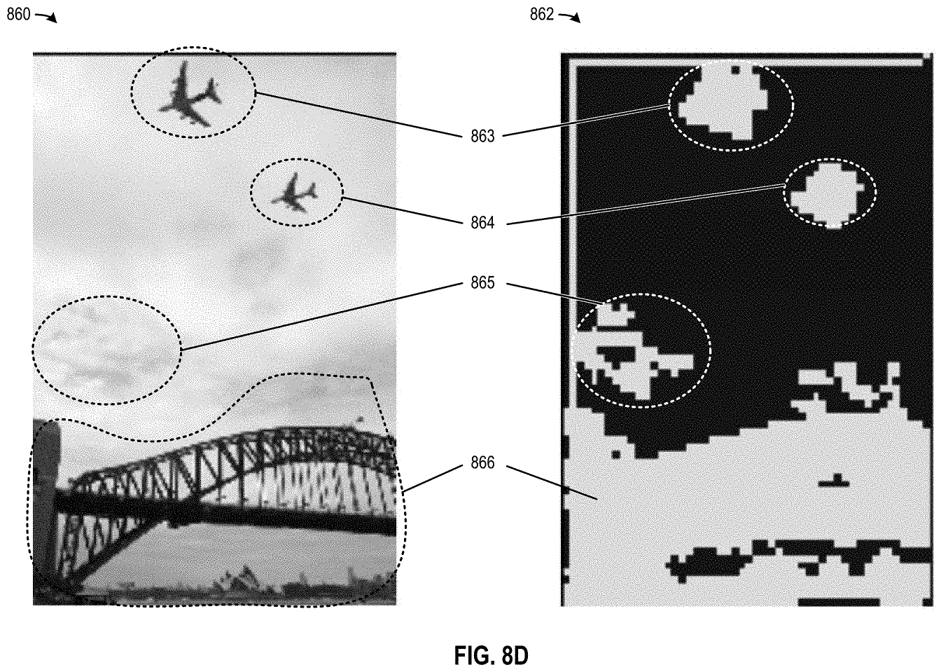

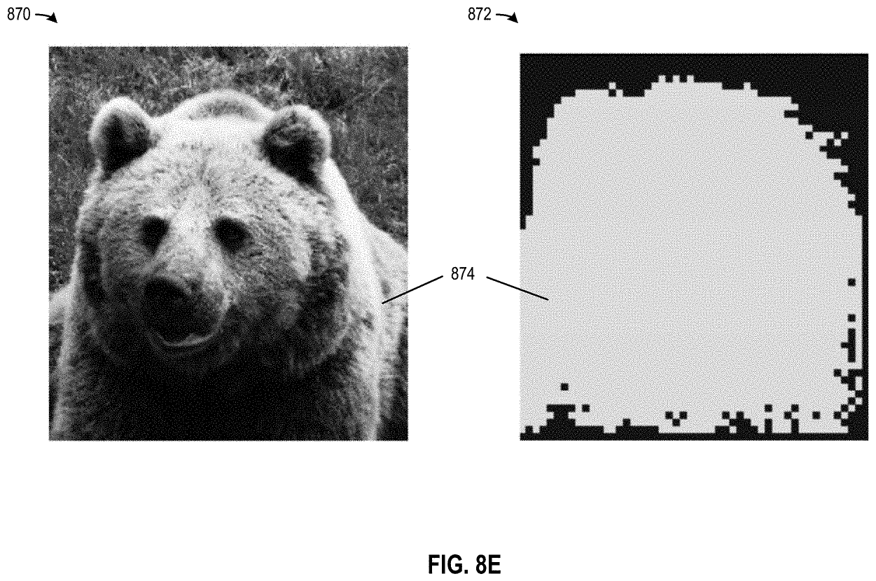

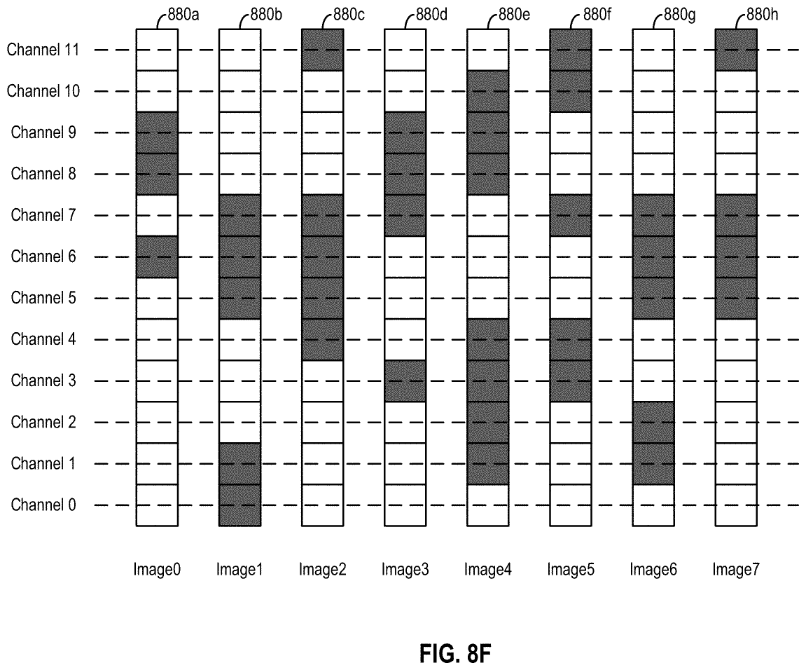

FIG. 8A illustrates an example of a convolution operation. As shown in FIG. 8A, a number of C filters 802 may correspond to the same number (C) of images 804. The set of filters 802 can represent features of a target object in C different channels, and images 804 can also correspond to the C different channels. For example, the set of C filters can correspond to a visible red channel, a visible blue channel, a visible green channel, and an infra-red channel. Each of images 804 can also correspond to one of the C different channels. The convolution results for each filter-image pair can be summed to generate a convolution output as follows, to generate a convolution array 806:

O_{e,f}=Σᵣ₌₀^{R-1}Σₛ₌₀^{S-1}Σ_{c=0}^{C-1}X^{c}_{eD+r,fD+s}×W^{c}_{r,s} (Equation 1)

Here, the convolution operation involves the images (or pixel arrays). X^{c}_{eD+r,fD+s} may refer to the value of a pixel at an image of index c, within the number (C) of images frames 760, with a row coordinate of eD+r and a column coordinate of fD+s. The index c can denote a particular input channel. D is the sliding-window stride distance, whereas e and f correspond to the location of the data element in the convolution output array, which can also correspond to a particular sliding window. Further, r and s correspond to a particular location within the sliding window. A pixel at an (r, s) location and of an image of index c can also correspond to a weight W^{c}_{r,s} in a corresponding filter of the same index c at the same (r, s) location. Equation 1 indicates that to compute a convolution output O_{e,f}, each pixel within a sliding window (indexed by (e, f)) may be multiplied with a corresponding weight W^{c}_{r,s}. A partial sum of the multiplication products within each sliding window for each of the images within the image set can be computed, and then a sum of the partial sums for all images of the image set can be computed. Convolution output O_{e,f} can indicate, for example, a likelihood of a pixel at the location (e, f) includes the features represented by filters 802, based on applying filters 802 on images 804 across the C channels.

The accuracy of the object detection operation can be improved using various techniques. For example, image sensor 600 can include a large number of pixel cells to generate high-resolution input images to improve the spatial resolutions of the images, as well as the spatial resolution of the features captured in the images. Moreover, the pixel cells can be operated to generate the input images at a high frame rate to improve the temporal resolutions of the images. The improved resolutions of the images allow the image processor to extract more detailed features to perform the object detection operation.

In addition, the image processor can employ a trained machine learning model to perform the object detection operation. The machine learning model can be trained, in a training operation, to learn about the features of the target object from a large set of training images. The training images can reflect, for example, the different operation conditions/environments in which the target object is captured by an image sensor, as well as other objects that are to be distinguished from the target object. The machine learning model can then apply model parameters learnt from the training operation to the input image to perform the object detection operation. Compared with a case where the image processor uses a fixed set of rules to perform the object detection operation, a machine learning model can adapt its model parameters to reflect complex patterns of features learnt from the training images, which can improve the robustness of the image processing operation.

One example of a machine learning model can include a deep neural network (DNN). FIG. 8B illustrates an example architecture of DNN 810 that can be implemented by an image processor. Referring to FIG. 8B, DNN 810 may include four main operations: (1) convolution; (2) processing by an activation function (e.g., ReLU); (3) pooling or sub-sampling; and (4) classification (fully connected layer). DNN 810 can be configured as an image processing neural network.

An image to be classified, such as images 804, may be represented by a tensor of pixel values. As discussed above, input images 804 may include images associated with multiple channels, each corresponding to a different wavelength range, such as a red channel, a green channel, and a blue channel. It is understood that images 804 can be associated with more than three channels, in a case where the channels represent a finer grain color palette (e.g., 256 channels for 256 colors).

As shown in FIG. 8B, input images 804 may be processed by a first convolution layer (e.g., an input layer) 814. The left of FIG. 8C illustrates an example of a convolution layer 814. As shown in FIG. 8C, convolution layer 814 can include a first layer of nodes 816 and a second layer of nodes 818 and can be associated with a first weights tensor [W₀]. A block of nodes of the first layer of nodes 816 is connected to a node in the second layer of nodes 818. For example, block of nodes 816a of the first layer is connected to node 818a in the second layer, whereas block of nodes 816b of the first layer is connected to node 818b in the second layer. To perform a convolution operation, such as the one described in Equation 1, a first block of pixels of input image 804 can be multiplied with first weights tensor [W₀] by block of nodes 816a of the first layer to generate products, and node 818a of the second layer can sum the products to generate a sum 820a. Moreover, a second block of pixels of input image 804 can be multiplied with first weights tensor [W₀] by block of nodes 816b of the first layer to generate products, and node 818b of the second layer can sum the products to generate a sum 820b.

Referring back to FIG. 8B, first convolution layer 814 can include multiple convolution layers associated with multiple channels, including layers 814a, 814b, and 814c. Each layer can have a first layer of nodes 816 and a second layer of nodes 818 as shown in FIG. 8C, and each layer can be associated with a different first weights tensor. For example, first convolution layer 814a can be associated with first weights tensor [W₀₋₀] of a first channel (e.g., a red channel), and first convolution layer 814b can be associated with first weights tensor [W₀₋₁] of a second channel (e.g., a green channel), whereas first convolution layer 814c can be associated with first weights tensor [W₀₋₂] of a third channel (e.g., a blue channel). The sums generated by the second layer of nodes 818 can then be post-processed by an activation function to generate intermediate output data. The activation function can simulate the behavior of the linear perceptron in the neural network. The activation function can include a linear function or a non-linear function (e.g., ReLU, SoftMax). The intermediate output data can form an intermediate output tensor 826. The first weights tensors can be used to, for example, extract certain basic features (e.g., edges) from images 804, and intermediate output tensor 826 can represent a distribution of the basic features as a basic feature map. In some examples, intermediate output tensor 826 may optionally be passed to a pooling layer 828, where intermediate output tensor 826 may be subsampled, down-sampled, and/or averaged by pooling layer 828 to generate an intermediate output tensor 830.

Intermediate output tensor 830 may be processed by a second convolution layer 834 using second weights tensors (labelled [W₁₋₀], [W₁₋₁], and [W₁₋₂] in FIG. 8B). Second convolution layer 832 can have a similar topology as first convolution layer 814 as shown in FIG. 8B, and can include second convolution layers 832a, 832b, and 832c associated with different channels. The second weights tensors can be used to, for example, identify patterns of features specific for an object, such as a hand, from intermediate output tensor 830. As part of the convolution operation, blocks of pixels of tensor 830 of a channel can be multiplied with the second weights tensor of the same channel to generate a product, and the products can be accumulated to generate a sum, as in first convolution layer 814. Each sum can also be then processed by an activation function to generate an intermediate output, and the intermediate output data can form an intermediate output tensor 836. Intermediate output tensor 836 may represent a spatial distribution of features representing a hand and across different channels. Intermediate output tensor 836 may be optionally passed to a pooling layer 838, where intermediate output tensor 836 may be subsampled, down-sampled, or averaged to generate an intermediate output tensor 840.

Intermediate output tensor 840 can then be passed through a fully connected layer 842, which can include a multi-layer perceptron (MLP). The right of FIG. 8C illustrates an example of fully connected layer 842. As shown in FIG. 8C, fully connected layer 842 can include a first layer of nodes 846 and a second layer of nodes 848. Each node in the second layer is connected to every node of the first layer. First layer of nodes 846 can multiply inputs (e.g., intermediate output tensor 840) with a third weights tensor (labelled [W₂] in FIG. 8C) to generate sums, such as sums 850a and 850b, and the sums can be processed by an activation function to generate a neural network output 852. Neural network output 852 can represent a classification of whether an object in images 804 represents a hand, and the likely pixel location of the hand in the image. Referring back to FIG. 8B, fully connected layer 842 can include layers 842a, 842b, and 842c associated with third weights tensors of different channels (labelled [W₂₋₀], [W₂₋₁], and [W₂₋₂] in FIG. 8C), and neural network output 852 can provide the classification for each channel.

DNN 810 can be implemented on a hardware system that provides computation and memory resources to support the DNN computations. For example, the hardware system can include a memory to store the input data, output data, and weights of each neural network layer. Moreover, the hardware system can include computation circuits, such as a general-purpose central processing unit (CPU), dedicated arithmetic hardware circuits, etc., to perform the computations for each neural network layer. The computation circuits can fetch the input data and weights for a neural network layer from the memory, perform the computations for that neural network layer to generate output data, and store the output data back to the memory. The output data can be provided as input data for a next neural network layer, or as classification outputs of the overall neural network for the input image.

While the accuracy of the image processing operation can be improved by increasing the resolutions of the input images, performing image processing operations on high resolution images can require substantial resources and power, which can create challenges especially in resource-constrained devices such as mobile devices. Specifically, in a case where DNN 810 is used to perform the image processing operation, the sizes of the neural network layers, such as first convolution layer 814, second convolution layer 834, and fully connected layer 842, may be increased, so that each layer has enough of a number of nodes to process the pixels in the high-resolution images. Moreover, as the feature patterns to be detected become more complex and detailed, the number of the convolution layers in DNN 810 may also be increased to use more convolution layers to detect different parts of the feature patterns. But the expanded neural network layer can lead to more computations to be performed by the computation circuits for the layer, while increasing the number of neural network layers can also increase the overall computations performed for the image processing operation. In addition, as the computations rely on input data and weights fetched from the memory, as well as storage of output data at the memory, expanding the neural network may also increase the data transfer between the memory and the computation circuits, which in turn can increase power consumption.

In addition, typically the target object to be detected is only represented by a small subset of pixels, which lead to spatial sparsity within an image. Moreover, the pixels of the target object may be associated with only a small subset of the wavelength channels, which lead to channel sparsity across images of different channels. Therefore, a lot of the power is wasted in generating, transmitting, and processing pixel data that are not useful for the object detection/tracking operation, which further degrades the overall efficiency of the image sensing and processing operations.

FIG. 8D and FIG. 8E illustrate examples of spatial sparsity, whereas FIG. 8F illustrates examples of channel sparsity. FIG. 8D illustrates an image 860 and a corresponding spatial sparsity map 862. As shown in FIG. 8D, in an image 860, only groups of pixels 863, 864, 865, and 866 include feature patterns that can be analyzed to determine whether those feature patterns form part of an object of interest to be detected/tracked (e.g., a plane, a building, a bridge, etc.). But the rest of pixels are part of an empty physical space (e.g., sky) and do not have detectable feature patterns of objects to be analyzed. Another example of spatial sparsity is illustrated in FIG. 8E, which shows an image 870 and its corresponding spatial sparsity map 872. As shown in FIG. 8E, in an image 870, group of pixels 874 includes feature patterns that can be analyzed to determine whether those feature patterns form part of an object of interest to be detected/tracked (e.g., a bear). But the rest of pixels are part of an empty physical space (e.g., landscape) and do not have detectable feature patterns of objects to be analyzed. As shown in FIG. 8D and FIG. 8E, a spatial sparsity map, which indicates the spatial locations of pixels in an image that contain useful information for detecting feature patterns of an object, typically varies between different input images capturing different scenes and different objects. Moreover, the spatial sparsity map may also change in a sequence of images captured in a scene and for an object due to the movement of the object.

FIG. 8F illustrates examples of channel sparsity maps 880a-880h for different images (labelled image0-image7). Each channel sparsity map can indicate the presence or absence of a particular channel, out of channels 0-12, in an image. Each channel can represent, for example, a wavelength range of light, a visible color channel, etc. A shaded channel can indicate that the channel is present in the image. An image can include multiple channels, such that pixels of the image represent intensities in multiple channels. For example, channels 6, 8, and 9 are present in image0, such that image0 can be split into an image representing a spatial distribution of intensities in channel 6, an image representing a spatial distribution of intensities in channel 8, and an image representing a spatial distribution of intensities in channel 9, similar to what is shown in FIG. 6D. Similar to spatial sparsity maps of FIG. 8D and FIG. 8E, the channel sparsity map can change between images, as different images may capture different feature patterns, and the different feature patterns may be represented by different intensity distributions in different channels.

### Input-Dependent Dynamic Sparsity Image Processor

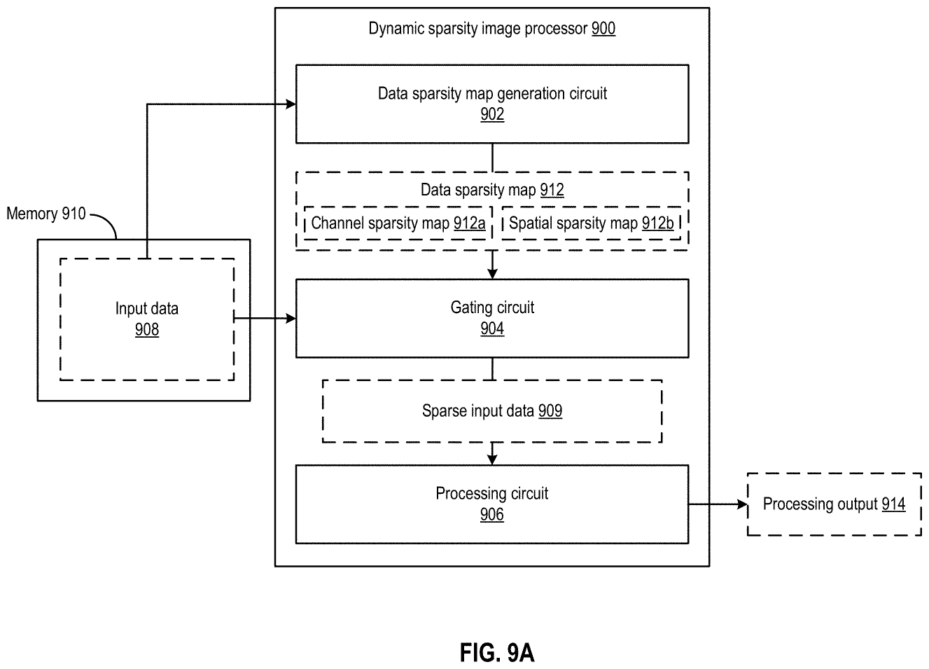

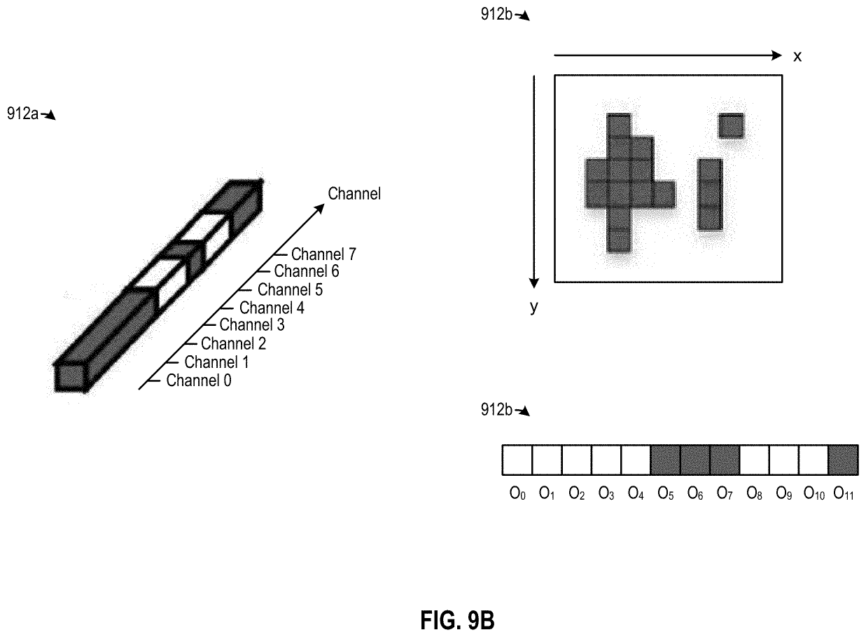

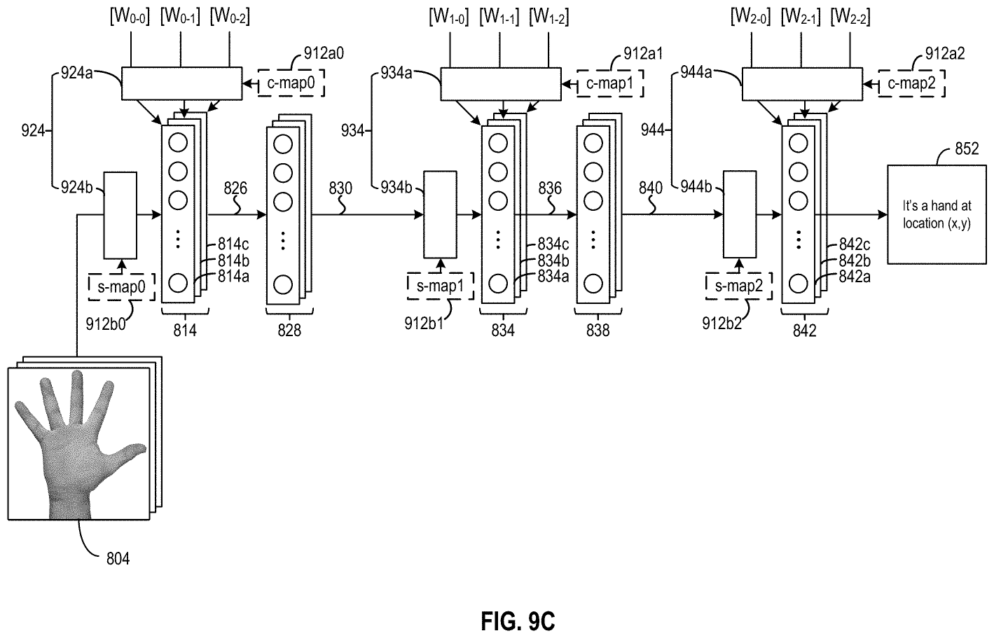

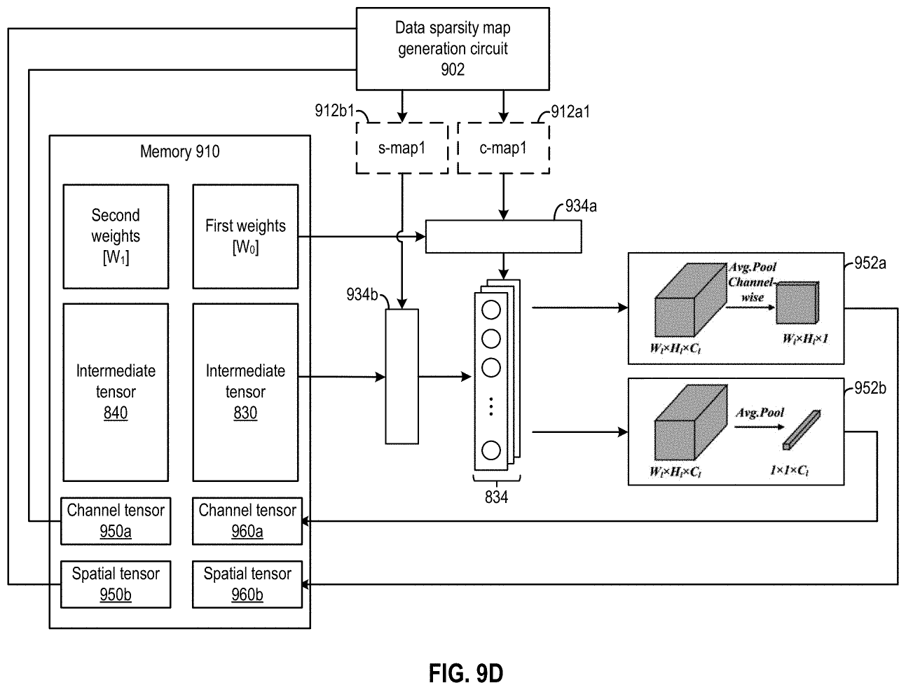

As discussed above, capturing high resolution images, and processing the high-resolution images using trained multi-level neural networks, can improve the accuracy of the image processing operation, but the associated computation and memory resources, as well as power consumption, can be prohibitive especially for mobile devices where computation and memory resources, as well as power, are very limited. FIG. 9A illustrates an example of a dynamic sparsity image processor 900 that can address at least some of the issues above. Referring to FIG. 9A, dynamic sparsity image processor 900 includes a data sparsity map generation circuit 902, a gating circuit 904, and a processing circuit 906. Data sparsity map generation circuit 902 can fetch input data 908 from a memory 910, and generate a data sparsity map 912 to select a first subset of input data 908 to be processed by processing circuit 906. Gating circuit 904 can selectively fetch the first subset of input data 908 from memory 910 as sparse input data 909, and provide sparse input data 909 to processing circuit 906, which can perform a sparse image processing operation on the first subset of input data 908 to generate a processing output 914. As to be described below, dynamic sparsity image processor 900 can be implemented in an integrated circuit, such as a neural network hardware accelerator.

Specifically, input data 908 may include one or more groups of data elements, with each group being associated with a channel of a plurality of channels. Each group may include a tensor. In some examples, input data 908 may include image data, with each group of data elements representing an image frame of a particular wavelength channel, and a data element can represent a pixel value of the image frame. Input data 908 may include multiple image frames associated with multiple channels. In some examples, input data 908 may be intermediate output data from a prior neural network layer and can include features of a target object extracted by the prior neural network layer. Each group of data elements can indicate absence/presence of certain features in a particular channel, as well as the locations of the features in an image frame of that channel. In some examples, as to be discussed below, input data 908 can be generated based on compressing the intermediate output data of a neural network layer. In some examples, input data 908 can be generated by performing an average pooling operation within each group of data elements of the intermediate output data, such that input data 908 retain the profile of channels but have reduced group size. In some examples, input data 908 can also be generated based on performing an average pooling operation across groups of data elements of the intermediate output data to reduce the number of groups/channels represented in input data 908. In addition, input data 908 may also include weights of a neural network layer to be combined with the image data and/or intermediate output data of the prior neural network layer.

As shown in FIG. 9A, data sparsity map 912 may include a channel sparsity map 912a and a spatial sparsity map 912b. Channel sparsity map 912a may indicate one or more channels associated with one or more groups of data elements to be selected from the plurality of groups of data, whereas spatial sparsity map 912b can indicate the data elements in the one or more groups that are selected to be part of the first subset of input data 908 in the one or more groups of data elements.

### Channel Gating and Spatial Gating

In some examples, both the channel sparsity map and the spatial sparsity map can include an array of binary masks, with each binary mask having one of two binary values (e.g., 0 and 1). FIG. 9B illustrates examples of channel sparsity map 912a and spatial sparsity map 912b. The left of FIG. 9B illustrates an example of channel sparsity map 912a, which can include a one-dimensional array of binary masks corresponding to the plurality of channels, with each binary mask indicating whether a particular channel is selected. In FIG. 9B, a shaded binary mask (representing a 1) may indicate that the corresponding channel is selected, while a blank binary mask (representing a 0) may indicate that the corresponding channel is not selected. The right of FIG. 9B illustrates examples of spatial sparsity map 912b. In some examples, spatial sparsity map 912b can include a two-dimensional array of binary masks corresponding to pixels of an image frame, with each binary mask indicating whether a corresponding pixel of the image frame is to be selected to be part of the first subset of input data 908. In some examples, spatial sparsity map 912b can include a one-dimensional array of binary masks corresponding to the intermediate output data of a neural network layer (represented by O0, O1, O2, . . . O11 in FIG. 9B).

Referring back to FIG. 9A, gating circuit 904 can selectively fetch, based on data sparsity map 912, the first subset of input data 908 to processing circuit 906, which can perform a sparse image processing operation on the first subset of input data 908 to generate a processing output 914. Although FIG. 9A illustrates that gating circuit 904 is separate from processing circuit 906, in some examples gating circuit 904 can also be part of processing circuit 906. For example, in a case where processing circuit 906 implements a multi-layer neural network, such as DNN 810, gating circuit 904 can include sub-circuits to implement a spatial gating circuit and a channel gating circuit for each neural network layer. In addition, the spatial gating circuit and channel gating circuit for each neural network layer can also receive different data sparsity maps 912 for different neural network layers.

FIG. 9C illustrates an example of processing circuit 906 including DNN 810 and spatial and channel gating circuits to form a dynamic sparse neural network. In the example of FIG. 9C, gating circuit 904 comprises a first gating layer 924 to select input data and weights for first convolution layer 814, a second gating layer 934 to select input data and weights for second convolution layer 834, and a third gating layer 944 to select input data and weights for fully connected layer 842. A gating layer may include a channel gating circuit to select weights for the neural network layer based on a channel sparsity map, such as channel sparsity maps 912a0, 912a1, and 912a2 (labelled c-map0, c-map1, and c-map2). In some examples, a gating layer may also include a spatial gating circuit to select input data for the neural network layer based on a spatial sparsity map, such as spatial sparsity maps 912b0, 912b1, and 912b2 (labelled s-map0, s-map1, and s-map2). In some examples, the spatial gating circuit may also select the input data based on the channel sparsity map, to filter out input data associated with channels not selected in the channel sparsity map. Although FIG. 9C shows that each gating layer includes a channel gating circuit and a spatial gating circuit, in some examples a gating layer may include either a channel gating circuit or a spatial gating circuit.

For example, first gating layer 924 may include a first channel gating circuit 924a to selectively fetch one or more first weights tensors [W₀₋₀], [W₀₋₁], and [W₀₋₂] based on the selected channels indicated in channel sparsity map 912a0. In addition, first gating layer 924 may include a first spatial gating circuit 924b to select pixels of images 804 corresponding to the selected pixels in spatial sparsity map 912b0. First gating layer 924 can also provide zero values (or other pre-determined values) for other pixels and weight tensors that are not selected as part of sparse inputs to first convolution layer 814. First convolution layer 814 can then perform computations on the sparse inputs including the selected first weights tensors and pixels to generate intermediate output tensor 826, followed by optional pooling operations by pooling layer 828, to generate intermediate output tensor 830.

In addition, second gating layer 934 may include a second channel gating circuit 934a to select one or more second weights tensors [W₁₋₀], [W₁₋₁], and [W₁₋₂] based on the selected channels indicated in channel sparsity map 912a1. In addition, second gating layer 934 may include a second spatial gating circuit 934b to select data elements of intermediate output tensor 830 corresponding to the selected data elements in spatial sparsity map 912b1. Second gating layer 934 can also provide zero values (or other pre-determined values) for other pixels and weight tensors that are not selected as part of sparse inputs to second convolution layer 834. Second convolution layer 834 can then generate intermediate output tensor 836 based on sparse inputs including the selected second weights tensors and data elements of intermediate output tensor 830, followed by optional pooling operations by pooling layer 838, to generate intermediate output tensor 840.

Further, third gating layer 944 may include a third channel gating circuit 944a to select one or more third weights tensors [W₂₋₀], [W₂₋₁], and [W₂₋₂] based on the selected channels indicated in channel sparsity map 912a2. In addition, third gating layer 944 may include a third spatial gating circuit 944b to select data elements of intermediate output tensor 840 corresponding to the selected data elements in spatial sparsity map 912b2. Third gating layer 944 can also provide zero values (or other pre-determined values) for other pixels and weight tensors that are not selected as sparse inputs to fully connected layer 842. Fully connected layer 842 can then generate output 852, as part of processing output 914, based on the sparse inputs.

In FIG. 9C, in addition to dynamically updating channel sparsity map 912a and spatial sparsity map 912b based on images 804, data sparsity map generation circuit 902 can also generate, for each of first convolution layer 814, second convolution layer 834, and fully connected layer 842, a different channel sparsity map 912a and a different spatial sparsity map 912b based on the input to that neural network layer. For example, data sparsity map generation circuit 902 can generate channel sparsity map 912a0 and spatial sparsity map 912b0 for first convolution layer 814 based on images 804. Moreover, data sparsity map generation circuit 902 can also generate channel sparsity map 912a1 and spatial sparsity map 912b1 for second convolution layer 834 based on intermediate output tensor 830, and generate channel sparsity map 912a2 and spatial sparsity map 912b2 for fully connected layer 842 based on intermediate output tensor 840.

Such arrangements allow processing circuit 906 to select, for each neural network layer, a different subset of the input data (which can be immediate output data from a prior neural network layer) and a different subset of the weights to perform computations for that neural network layer. Moreover, for different neural network layers, and for different neural network topologies, different types of gating may be used. For example, only spatial gating is applied to the input data of some neural network layers, with all channels enabled by the channel sparsity map. Moreover, only channel gating is applied to the input data of some other neural network layers, with all pixels/data elements of each channel of the input data provided to those neural network layers.

Having different channel sparsity maps and spatial sparsity maps for different neural network layers, and for different neural network topologies, can provide finer granularity in leveraging the spatial sparsity and channel sparsity of neural network computations, which in turn can further improve the accuracy and efficiency of the image processing operation. Specifically, as described above, first convolution layer 814 and second convolution layer 834 may be configured to detect different sets of features of the target object from input image 804, whereas fully connected layer 842 may be configured to perform classification operation on the features. For example, first convolution layer 814 may detect basic features such as edges to distinguish an object from a background, whereas second convolution layer 834 may detect features specific to the target object to be detected. The input and output features by different neural network layers can be at different locations in the input data, and can also be associated with different channels. Therefore, different channel and spatial sparsity maps can be used to select different subsets of input data associated with different channels for first convolution layer 814, second convolution layer 834, and fully connected layer 842.

In addition, some network topologies, such as Mask R-CNN, do not work well with uniform gating because those network topologies may include different sub-networks, such as feature extractor, region proposed network, region of interest (ROI) pooling, classification, etc., each of which has a different sensitivity (e.g., in terms of accuracy and power) toward spatial and channel gating. Therefore, by providing different spatial sparsity maps and different channel sparsity maps for different neural network layers, and for different neural network topologies, processing circuit 906 can select the right subset of input data for each neural network layer, and for a particular neural network topology, to perform the image processing operation, which in turn can further improve the accuracy of the image processing operation while reducing power.

In some examples, different combinations of channel and spatial gating can be applied to different neural network layers of a neural network. For example, as described above, for some neural network layers, one of channel gating or spatial gating is used to select the subset of input, whereas for some other neural network layers, both channel gating and spatial gating are used to select the subset of input. Specifically, in some cases, only one of channel gating or spatial gating is used to select the subset of input to reduce accuracy loss. Moreover, in some cases, channel gating can be disabled for neural network stages involved in extraction of features (e.g., first convolution layer 814, second convolution layer 834, etc.) if the object features tend to spread across different channels. In such cases, channel gating can be used to provide sparse input to fully connected layer 842.

### Training

The dynamic sparse neural network of FIG. 9C, comprising DNN 810 and gating layers 924, 934, and 944, can be trained with the objective of maximizing the task accuracy under certain sparsity constraints. A sparsity-induced loss can be defined as follows:

$${L}_{sparsity}^{l} = MSE ( \frac{{\sum }_{l} {C}_{sparse , l}}{{\sum }_{l} {C}_{dense , l}} , θ ) \qquad ( Equation 2 )$$

In Equation 2, C_{sparse,1} and C_{dense,1} denote the number of MAC (multiple-and-add) operations in convolution layer 1 with and without the dynamic sparsity, respectively. θ is a hyper-parameter to control the sparsity for the overall network, which in turn controls the overall compute.

In some examples, relying only on the sparsity-induced loss could lead to uneven sparsity distribution across the layers, especially in large networks. For instance, in ResNet some layers may be virtually skipped altogether as residual connections can recover the feature map dimension. To maintain sufficient density for each individual layer, the loss function can include a loss term L_{penalty} that penalizes the loss if the sparsity of a layer exceeds certain threshold B, as follows:

$${L}_{penalty} = {\sum }_{{l}_{i}}^{l} Min ( MSE ( \frac{{C}_{sparse , li}}{{C}_{dense , li}} , θ ) , {B}_{upper} ) \qquad ( Equation 3 )$$

In Equation 3, a ratio C_{sparse,li}/C_{dense,li} can represent a percentage of computation required for a layer MSE can represent a mean square function, whereas theta θ can represent a target sparsity for a layer. The MSE output can represent total differences between the ratio C_{sparse,li}/C_{dense,li} and theta θ for each layer. With a higher sparsity, C_{sparse,li}/C_{dense,li} can become lower, which can result in a lower penalty in general. The Min (minimum) function can compare the MSE output with a threshold represented by Bᵤₚₚₑᵣ to obtain a minimum between the MSE output and the threshold to generate a penalty for each layer. With the minimum function, Bᵤₚₚₑᵣ can be an upper bound for the penalty. The penalty for each layer can then be summed to generate the loss term L_{penalty}.

The overall loss function L to be optimized in training of the dynamic sparse neural network of FIG. 9C can be based on a weighted sum of three losses: the task loss Ltask, the sparsity-induced loss Lsparsity, and the penalty term Lpenalty:

L=Lₜₐₛₖ+αL_{sparsity}+βL_{penalty} (Equation 4)

In Equation 4, the task loss Lₜₐₛₖ can be the loss function of DNN 810 without the gating layer and based on differences between the outputs of DNN 810 and the target outputs for a set of training inputs, whereas L_{sparsity} and L_{penalty} are defined in Equations 2 and 3 above. The weights α and β can provide a way to inform the training process of whether to emphasize on reducing the sparsity-induced loss L_{sparsity}, which can reduce sparsity, or reducing the penalty term L_{penalty}, which can increase sparsity. In some examples, the weights α and β can be both 1.0.

### Memory Transfer Operation for Input-Dependent Dynamic Gating

In the example of FIG. 9C, each gating layer can selectively fetch pixels or data elements of an intermediate output tensor, as well as weight tensors, from memory 910 based on the channel sparsity map and the spatial sparsity map for the neural network layer, to reduce the memory data transfer to support the neural network computations at each neural network layer. In some examples, each neural network layer may skip computations such as additions and multiplications involving zero inputs (e.g., pixels, data elements of an intermediate output tensor, weights, etc.), to further reduce the computations involved in the processing of the sparse inputs.

In some examples, to reduce the memory data transfer involved in the generation of the spatial sparsity map and the channel sparsity map for a neural network layer, the image processing circuit can store both the intermediate output tensor from a previous neural network layer, as well as a compressed intermediate output tensor, at memory 910. Data sparsity map generation circuit 902 can then fetch the compressed intermediate output tensor from memory 910 to generate data sparsity map 912. Compared with a case where the data sparsity map generation circuit 902 fetches the entirety of the intermediate output tensor from memory 910 to generate data sparsity map 912, such arrangements allow data sparsity map generation circuit 902 to fetch less data, which can reduce the memory data transfer involved in the data sparsity map generation, as well as the overall memory data transfer involved in the sparse image processing operation.

FIG. 9D illustrates examples of generation and storage of a compressed intermediate output tensor at memory 910. As shown in FIG. 9D, memory 910 can store first weights tensor [W₀], second weights tensor [W₁], intermediate tensor 830, as well as channel tensor 950a and spatial tensor 950b. Specifically, after first convolution layer 814 (and optionally pooling layer 828) generates intermediate tensor 830, DNN 810 can perform additional pooling operations on intermediate tensor 830 to generate a channel tensor 950a and a spatial tensor 950b. In FIG. 9D, intermediate tensor 830 can include a Cₗ number of groups of data elements, with each group having a tensor of a dimension Wₗ×Hₗ and corresponding to a channel. Channel tensor 950a can be generated by an inter-group pooling operation 952b (e.g., average pooling, subsampling, etc.) within each group of data elements, and channel tensor 950a can retrain the same pattern of channels and the same number of groups as the intermediate output tensor 830, but each group has a reduced number of data elements (e.g., one data element in FIG. 9D). In addition, spatial tensor 950b can be generated by a channel-wise pooling operation 952a (e.g., average pooling, subsampling, etc.) across the channels of intermediate tensor 830, and spatial tensor 950b can retain the number of data elements in a group as intermediate tensor 830, but have a reduced number of channels and groups (e.g., one channel/group in FIG. 9D).

Data sparsity map generation circuit 902 can then fetch channel tensor 950a and spatial sparsity tensor 950b from memory 910, instead of fetching intermediate tensor 830, and generate channel sparsity map 912a1 based on channel tensor 950a and spatial sparsity map 912b1 based on spatial tensor 950b. As data sparsity map generation circuit 902 does not need to fetch intermediate tensor 830 for the data sparsity map generation, the memory data transfer involved in the data sparsity map generation can be reduced.

Channel gating circuit 934a can fetch a subset of first weights [W0] from memory 910 to second convolution layer 834 based on channel sparsity map 912a1, whereas spatial gating circuit 934b can fetch a subset of intermediate tensor 830 from memory 910 to second convolution layer 834 based on spatial sparsity map 912b1. After the computations at second convolution layer 834 (and optionally pooling layer 838) complete and intermediate tensor 840 is generated, another inter-group pooling operation 952a can be performed on intermediate tensor 840 to generate channel tensor 960a, and another channel-wise pooling operation 952b can be performed on intermediate tensor 840 to generate spatial tensor 960b. Channel tensor 960a, spatial tensor 960b, as well as intermediate tensor 840 can be stored back to memory 910. Together with second weights [W1], all these data can support computations for the next neural network layer, such as fully connected layer 842.

In some examples, data sparsity map generation circuit 902 can generate data sparsity map 912 based on detecting patterns of features and/or channels of a target object in the input data. For example, from a channel tensor (e.g., channel tensors 950a/960a of FIG. 9D), data sparsity map 912 can detect a pattern of channels associated with the target object (or the features of the target object) in the input data, and generate a channel sparsity map based on the detected pattern of channels. Moreover, from a spatial tensor (e.g., spatial tensors 950b/960b of FIG. 9D), data sparsity map 912 can detect a spatial pattern of pixels representing the features of the target object in the input data, and generate a spatial sparsity map based on the detected spatial pattern of pixels.

### Machine-Learning Based Gating Circuits

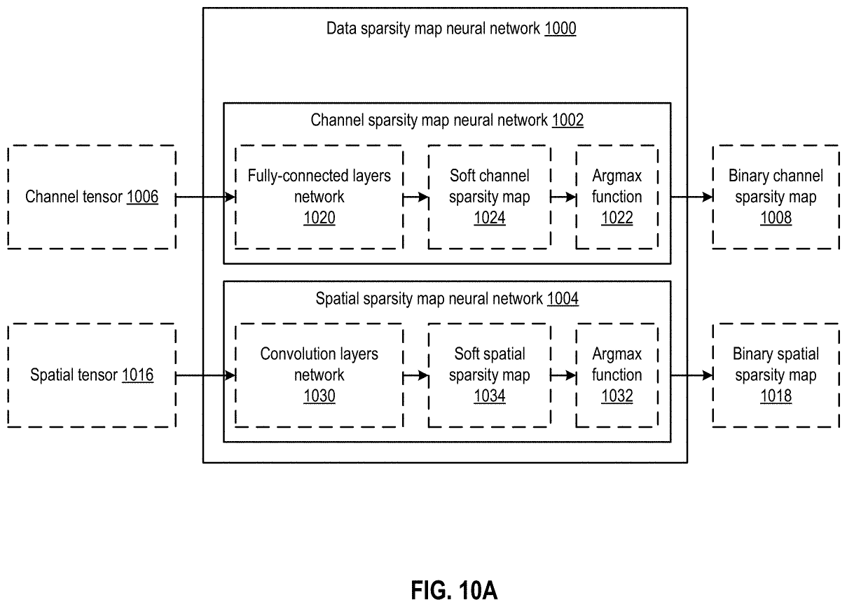

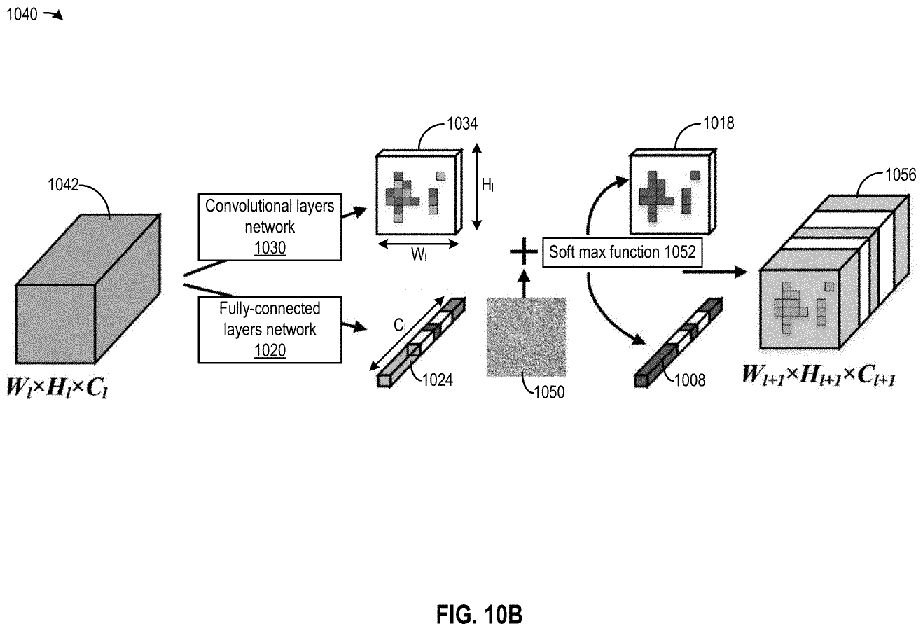

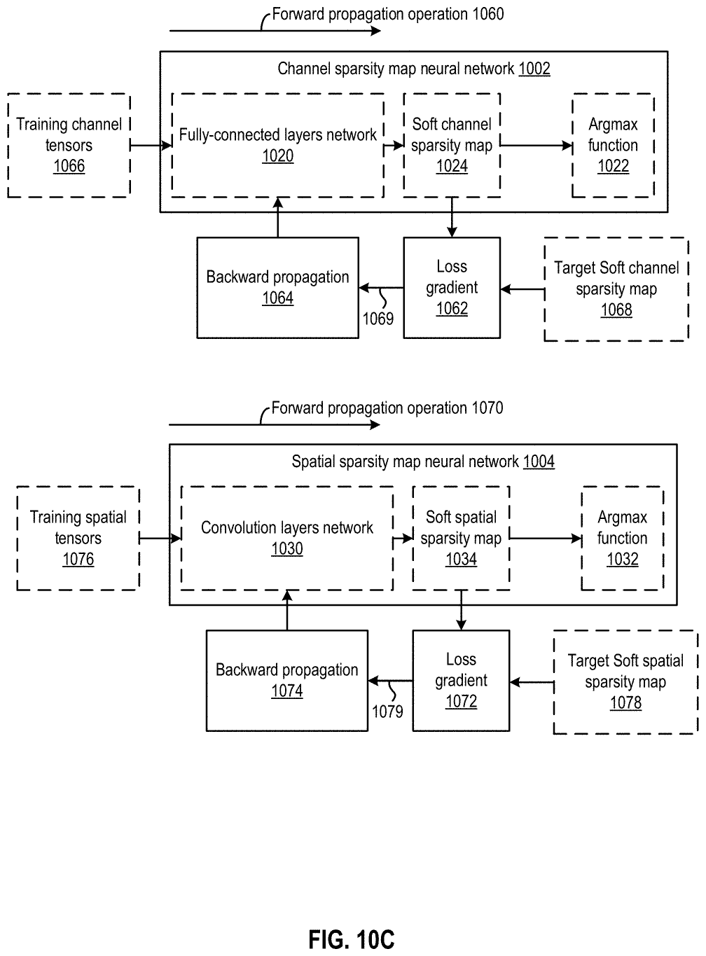

In some examples, data sparsity map generation circuit 902 can use a machine learning model, such as a neural network, to learn about the patterns of features and channels in the input data to generate the data sparsity map. FIG. 10A illustrates an example of a data sparsity map neural network 1000 that can be part of data sparsity map generation circuit 902. In some examples, data sparsity map neural network 1000 can be part of gating layers 924, 934, and 944 of FIG. 9C. As shown in FIG. 10A, data sparsity map neural network 1000 can include one or more data sparsity map neural networks, including a channel sparsity map neural network 1002 and a spatial sparsity map neural network 1004. Channel sparsity map neural network 1002 can receive a channel tensor 1006 generated from the input data for a neural network layer of an image processing neural network (e.g., DNN 810) and generate a channel sparsity map 1008 (labelled c-map), whereas spatial sparsity map neural network 1004 can receive a spatial tensor 1016 generated from the input data and generate a spatial sparsity map 1018 (labelled s-map).

Specifically, channel sparsity map neural network 1002 can include a fully connected layers network 1020, and implements an argmax activation function 1022. Fully connected layers network 1020 can receive channel tensor 1006 and generate a soft channel sparsity map 1024 with each soft mask, each having a number from a numerical range (e.g., between 0 and 1) to indicate the probability of a channel (for a soft channel sparsity map) or a pixel (for a soft spatial sparsity map) being associated with an object of interest. An activation function, such as an argmax function, can be applied to the set of soft masks to generate a set of binary masks, with each binary mask having a binary value (e.g., 0 or 1) to select a channel or a pixel. In addition, spatial sparsity map neural network 1004 can include a convolution layers network 1030, and implements an argument of the maxima (argmax) activation function 1032. Convolution layers network 1030 can receive spatial tensor 1016 and generate a soft spatial sparsity map 1034 with each soft mask having a number from a numerical range (e.g., between 0 and 1). The argmax activation function 1032 can be applied to soft spatial sparsity map 1034 to generate binary spatial sparsity map 1018, which can also include binary masks each having a binary value (e.g., 0 or 1). The argmax function can represent a sampling of a distribution of channels and pixels that maximizes the likelihood of the sample representing part of the object of interest.

Both channel sparsity map neural network 1002 and spatial sparsity map neural network 1004 can be trained by a training set of input data. In a case where the data sparsity map generation circuit generates a data sparsity map for each neural network layer of the image processing neural network, the data sparsity map neural network can be trained using a training set of input data for that image processing neural network layer, such that different image processing neural network layers can have different data sparsity maps.

A neural network can be trained using a gradient descent scheme, which includes a forward propagation operation, a loss gradient operation, and a backward propagation. Through forward propagation operation, each neural network layer having an original set of weights can perform computation on a set of training inputs to compute outputs. A loss gradient operation can be performed to compute a gradient of differences between the outputs and target outputs of the neural network (loss) for the training inputs with respect to the outputs as the loss gradient. The objective of the training operation is to minimize the differences. Through backward propagation, the loss gradient can be propagated back to each neural network layer to compute a weight gradient, and the set of weights of each neural network layer can be updated based on the weight gradient. The generation of binary masks by channel sparsity map neural network 1002 and spatial sparsity map neural network 1004, however, can pose challenges to the gradient descent scheme. Specifically, argmax activation functions 1022 and 1032 applied to the soft masks to generate the binary masks are non-differentiable mathematical operations. This makes it challenging to compute the loss gradients from the binary masks to support the backward propagation operations.

To overcome the challenge posted by the non-differentiability of the activation function, the data sparsity map neural network can employ parameterization and approximation techniques, such as Gumbel-Softmax Trick, to provide a differentiable approximation of argmax. FIG. 10B illustrates an example of Gumbel-Softmax Trick 1040 performed in channel sparsity map neural network 1002 and spatial sparsity map neural network 1004. As shown in FIG. 10B, from input data 1042, soft channel sparsity map 1024 can be generated by fully connected layers network 1020, whereas soft spatial sparsity map 1034 can be generated by convolution layers network 1030. Input data 1042 may include a tensor having a dimension of Wₗ×Hₗ, with a Cₗ number of channels defined for a neural network layer 1. Soft channel sparsity map 1024 can have a set of soft masks for each of Cₗ channels, whereas soft spatial sparsity map 1034 can have a set of soft masks for each data element within the Wₗ×Hₗ dimensions. Random numbers 1050 from a Gumbel distribution can be added to the soft masks of soft channel sparsity map 1024 and soft spatial sparsity map 1034 as sampling noise, followed by applying a soft max function 1052 on the soft masks with the sampling noise to generate binary masks including binary channel sparsity map 1008 and binary spatial sparsity map 1018. The soft max function can provide a differentiable approximation of argmax function 1022/1032 of FIG. 10A, whereas the addition of random numbers from a Gumbel distribution allows the sampling (using argmax or soft max approximation) to be refactored into a deterministic function, which allows the loss gradient to be computed using parameters of the deterministic function for the backward propagation operation. An example of the deterministic function, based on a soft max function, is as follows:

$${y}_{i} = exp ( \frac{exp ( \frac{{G}_{i} + log ( {π}_{i} )}{τ} )}{( \frac{{\sum }_{j} exp ( {G}_{j} + log ( {π}_{j} ) )}{τ} )} ) \qquad ( Equation 5 )$$

In Equation 5 above, yᵢ can represent a binary mask for a channel or for a pixel associated with an index i. Gᵢ represents a random number from a Gumbel distribution, whereas π (πᵢ and πⱼ) represents a soft mask value as input. τ represents the temperature variable which determines how closely the new samples approximate the argmax function. In some examples, tau can have a value of 0.7.

Binary channel sparsity map 1008 and binary spatial sparsity map 1018 can then be used by gating circuit 904 of FIG. 9A (not shown in FIG. 10B) to fetch sparse input data 1056 comprising, for example, a subset of pixel data/intermediate output data in the Wₗ×Hₗ dimensions, associated with a subset of the Cₗ channels. In FIG. 9A, sparse input data 1056 can have Wₗ₊₁×Hₗ₊₁ dimensions associated with Cₗ₊₁ channels for neural network layer l+1.

FIG. 10C illustrates examples of training operations for channel sparsity map neural network 1002 and spatial sparsity map neural network 1004. As shown in FIG. 10C, a training operation for channel sparsity map neural network 1002 can involve a forward propagation operation 1060, a loss gradient operation 1062, and a backward propagation operation 1064, whereas a training operation for spatial sparsity map neural network 1004 can involve a forward propagation operation 1070, a loss gradient operation 1072, and a backward propagation operation 1074.

Specifically, as part of forward propagation operation 1060, fully connected layers network 1020 with a set of weights can receive training channel tensors 1066 and generate soft channel sparsity map 1024. Loss gradient operation 1062 can compute a loss gradient 1069 with respect to the parameters of Equation 5. Loss gradient 1069 can be based on a difference between soft channel sparsity map 1024 and target soft channel sparsity map 1068 associated with training channel tensors 1066, and based on a derivative of the deterministic function of Equation 5 with respect to soft channel sparsity map 1024. Loss gradient 1069 can then be propagated back to each layer of fully connected layers network 1020 to compute the weight gradients at each layer, and the weights at each layer of fully connected layers network 1020 can be updated based on the weight gradients.

In addition, as part of forward propagation operation 1070, convolution layers network 1030 with a set of weights can receive training channel tensors 1066 and generate soft channel sparsity map 1024. Loss gradient operation 1072 can compute a loss gradient 1079 with respect to the parameters of Equation 5. Loss gradient 1079 can be based on a difference between soft spatial sparsity map 1034 and target soft spatial sparsity map 1078 associated with training spatial tensors 1076, and based on a derivative of the deterministic function of Equation 5 with respect to soft spatial sparsity map 1034. Loss gradient 1079 can then be propagated back to each layer of convolution layers network 1030 to compute the weight gradients at each layer, and the weights at each layer of convolution layers network 1030 can be updated based on the weight gradients.

### Example Implementations on Neural Network Hardware Accelerator

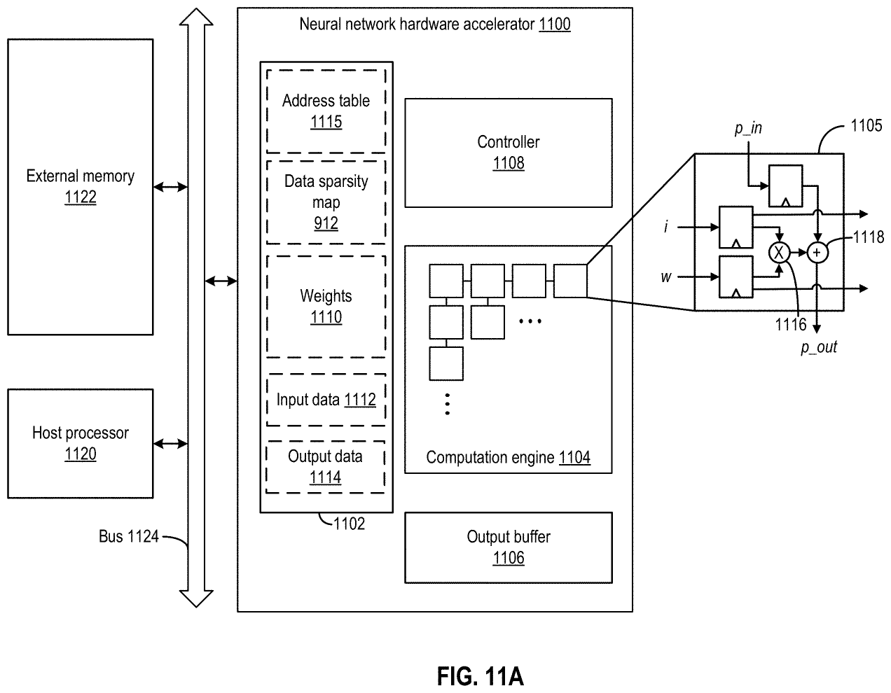

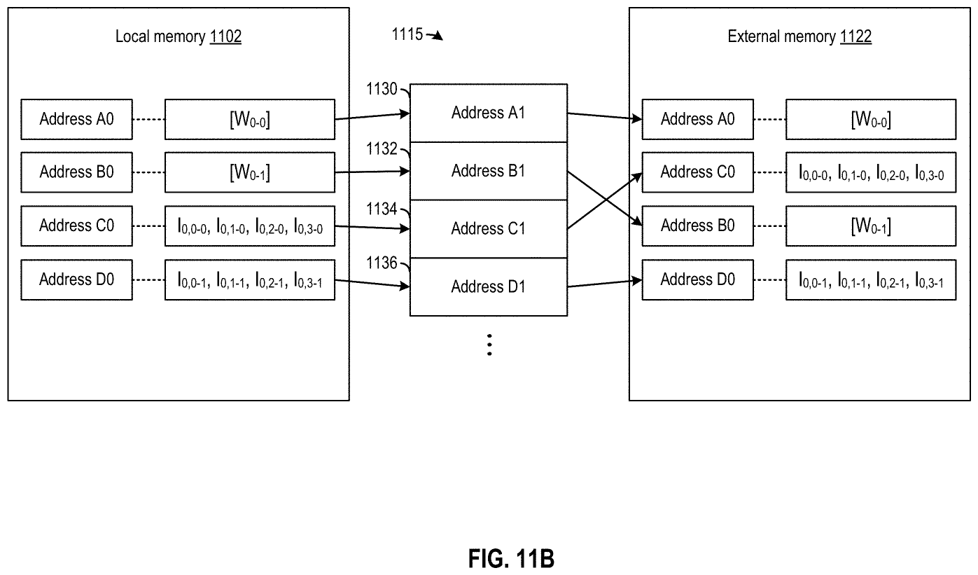

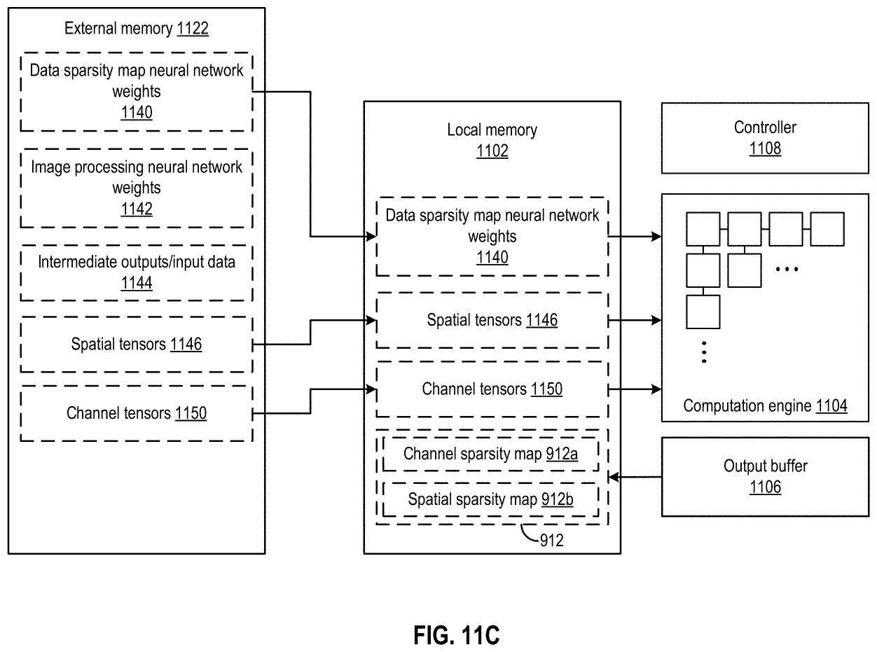

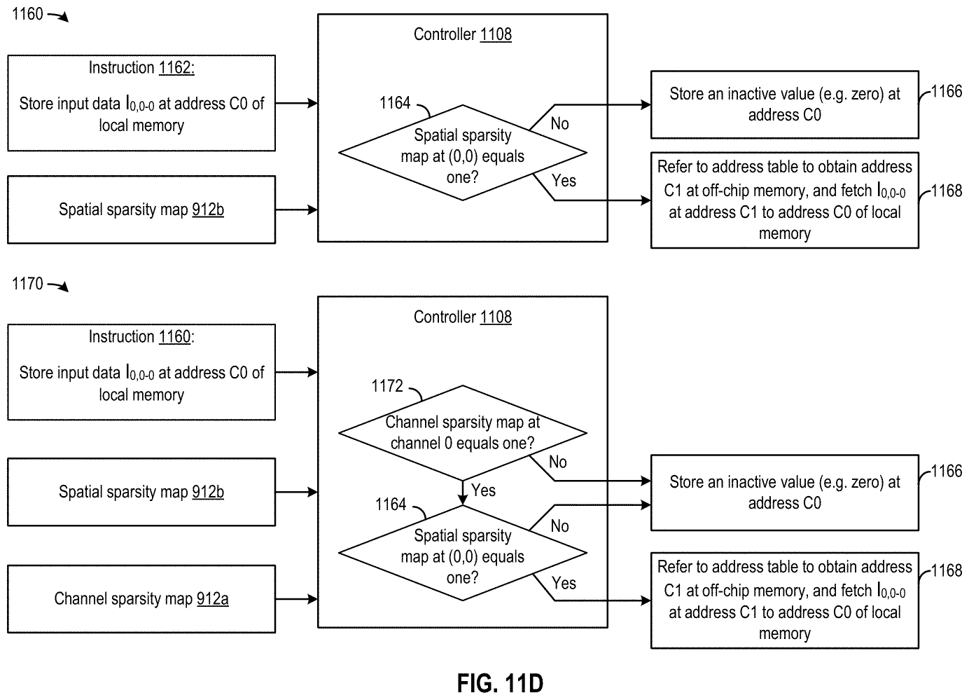

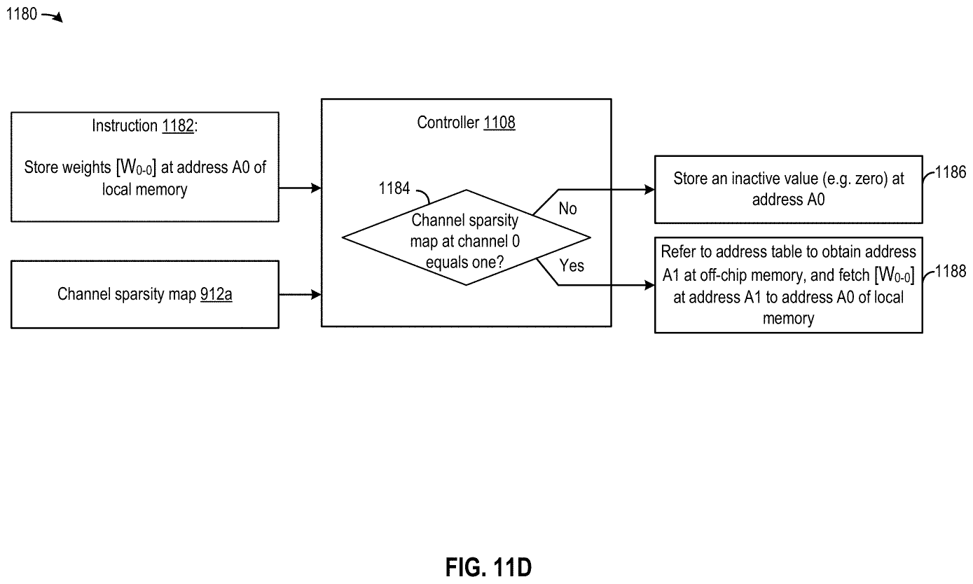

In some examples, dynamic sparsity image processor 900, including DNN 810, channel sparsity map neural network 1002, and spatial sparsity map neural network 1004, can be implemented on a neural network hardware accelerator. FIG. 11A illustrates an example of a neural network hardware accelerator 1100. As shown in FIG. 11A, neural network hardware accelerator 1100 can include an on-chip local memory 1102, a computation engine 1104, an output buffer 1106, and a controller 1108. On-chip local memory 1102 can store data to support computations for a neural network layer, including data sparsity map 912, weights 1110, input data 1112, and output data 1114. On-chip local memory 1102 may also store an address table 1115 to facilitate transfer of data to on-chip local memory 1102, as to be described below. On-chip local memory 1102 can be implemented using, for example, static random-access memory (SRAM), magnetoresistive random-access memory (MRAM), etc.

In addition, computation engine 1104 can include an array of processing elements, such as processing element 1105, each including arithmetic circuits such as multipliers and adders to perform neural network computations for the neural network layer. For example, a processing element may include a multiplier 1116 to generate a product between an input data element (i) and a weight element (w) to generate a product, and an adder 1118 to add the product to a partial sum (p_in) to generate an updated partial sum (p_out), as part of a multiply-and-accumulate (MAC) operation. In some examples, the array of processing elements can be arranged as a systolic array. Furthermore, output buffer 1106 can provide temporary storage for the outputs of computation engine 1104. Output buffer 1106 can also include circuits to perform various post-processing operations, such as pooling, activation function processing, etc., on the outputs of computation engine 1104 to generate the intermediate output data for the neural network layer.

Neural network hardware accelerator 1100 can also be connected to other circuits, such as a host processor 1120 and an off-chip external memory 1122, via a bus 1124. Host processor 1120 may host an application that uses the processing result of dynamic sparsity image processor 900, such as an AR/VR/MR application. Off-chip external memory 1122 may store input data to be processed by DNN 810, as well as other data, such as the weights of DNN 810, channel sparsity map neural network 1002, and spatial sparsity map neural network 1004, as well as intermediate output data at each neural network layer. Some of the data, such as the input data and the weights, can be stored by host processor 1120, whereas the intermediate output data can be stored by neural network hardware accelerator 1100. In some examples, off-chip external memory 1122 may include dynamic random-access memory (DRAM). Neural network hardware accelerator 1100 may also include a direct memory access (DMA) engine to support transfer of data between off-chip external memory 1122 and local memory 1102.

To perform computations for a neural network layer, controller 1108 can execute instructions to fetch input data and weights for the neural network layer from external off-chip memory 1122, and store the input data and weights at on-chip local memory 1102. Moreover, after the computations complete and output buffer 1106 stores the intermediate output data at on-chip local memory 1102, controller 1108 can fetch the intermediate output data and store them at external off-chip memory 1122. To facilitate transfer of data between off-chip memory 1122 and on-chip local memory 1102, address table 1115 can store a set of physical addresses of external off-chip memory 1122 at which controller 1108 is to fetch input data and weights and to store intermediate output data.

In some examples, address table 1115 can be in the form of an address translation table, such as a translation lookaside buffer (TLB), that further provides translation between addresses of on-chip local memory 1102 and external off-chip memory 1122. FIG. 11B illustrates an example of address table 1115. As shown in FIG. 11B, address table 1115 can include a page table having multiple entries, with each entry in the page table being mapped to a block/page in on-chip local memory 1102. The pages of on-chip local memory 1102 can be pre-predetermined, e.g., by a memory allocation operation by compiler that generates the instructions, to store certain data. For example, entry 1130 can be mapped to address A0 of on-chip local memory 1102 which is allocated by the compiler to store elements of first weights tensor [W0-0] of a first channel. Entry 1130 also stores an address A1 of external off-chip memory 1122 that stores [W0-0]. Moreover, entry 1132 can be mapped to address B0 of on-chip local memory 1102 which is allocated to store elements of second weights tensor [W0-1] of a second channel. Entry 1132 also stores an address B1 of off-chip external memory 1122 that stores [W0-1]. Further, entry 1134 can be mapped to address C0 of on-chip local memory 1102 which is allocated to store elements of input data of the first channel including I0,0-0, I0,1-0, I0,2-0, I0,3-0. Entry 1134 also stores an address C1 of off-chip external memory 1122 that stores the elements of intermediate outputs of the first channel. In addition, entry 1136 can be mapped to address D0 of on-chip local memory 1102 which is allocated to store elements of intermediate outputs of the second channel including I0,0-1, I0,1-1, I0,2-1, I0,3-1. Entry 1134 also stores an address D1 of off-chip external memory 1122 that stores the elements of intermediate outputs of the second channel.

To fetch data to or from an address in local memory 1102, controller 1108 can refer to address table 1115 and determine the entry mapped to the address in local memory 1102. Controller 1108 can then retrieve the address of off-chip external memory 1122 stored in the entry, and then perform data transfer between the addresses of local memory 1102 and off-chip external memory 1122. For example, to perform computations for a neural network layer, controller 1108 can store first weights tensor [W₀₋₀] of the first channel at address A0 of local memory 1102, second weights tensor [W₀₋₁] of the second channel at address B0 of local memory 1102, input data of the first channel at address C0 of local memory 1102, and input data of the second channel address D0 of local memory. Controller 1108 can access entries of address table 1115 mapped to addresses A0, B0, C0, and D0 of local memory 1102 to retrieve addresses A1, B1, C1, and D1 of off-chip external memory 1122, fetch the weights tensors and the input data from the retrieved addresses, and store the weights tensors and the input data at A0, B0, C0, and D0 of local memory 1102. Controller 1108 can then control computation engine 1104 to fetch the input data and weights from local memory 1102 to perform the computations. After output buffer 1106 completes the post-processing of the outputs of the computation engine and stores the intermediate outputs at local memory 1102, controller 1108 can refer to address table 1115 to obtain the addresses of off-chip external memory 1122 to receive the intermediate outputs, and store the intermediate outputs back to off-chip external memory 1122 at those addresses.

FIG. 11C-FIG. 11E illustrate examples of operations of neural network hardware accelerator 1100 to perform sparse image processing operations. Controller 1108 can use computation engine 1104 to perform computations for data sparsity map neural network 1000 to generate data sparsity map 912, and then use data sparsity map 912, together with address table 1115, to selectively fetch subsets of input data and weights to computation engine 1104 to perform a sparse image processing operation. Specifically, referring to FIG. 11C, off-chip memory 1102 may store weights of 1140 data sparsity map neural network 1000 for each layer of an image processing neural network (e.g., DNN 810), weights 1142 for each layer of the image processing neural network, intermediate outputs/input data 1144 of layers of DNN 810 for which the computations have been completed and to be provided as inputs to other layers of DNN 810, as well as spatial tensors 1146 and channel tensors 1148 obtained from pooling operations on intermediate outputs 1144.

Prior to performing computations for a layer of DNN 810, controller 1108 can use address table 1115 to determine the addresses of weights 1140 of data sparsity map neural network 1000 for that layer, as well as spatial tensors and/or channel tensors generated from the intermediate outputs of a prior layer, at external memory 1122. Data sparsity map neural network 1000 may include channel sparsity map neural network 1002 to perform channel gating, spatial sparsity map neural network 1004 to perform spatial gating, or both neural networks 1002 and 1004 to perform both spatial and channel gating. Controller 1108 can then fetch the weights as well as the spatial tensors and/or channel tensors from off-chip external memory 1122 and store them at local memory 1102. Controller 1108 can then control computing engine 1104 to perform neural network computations using weights 1140 and spatial tensors 1146 and/or channel tensors 1150 to generate data sparsity map 912, which may include channel sparsity map 912a and/or spatial sparsity map 912b for the layer of DNN 810, and store data sparsity map 912 at local memory 1102.

Controller 1108 can then implement gating circuit 904 using address table 1115 and data sparsity map 912 to selectively fetch a subset of intermediate outputs 1144 as input data for the DNN 810 layer. Controller 1108 may also selectively fetch subset of weights 1142 of the DNN 810 layer to local memory 1102. FIG. 11D illustrates example operations of controller 1108 in selecting a subset of input data 1144. Referring to operation 1160 of FIG. 11D, controller 1108 may receive an instruction 1162 to store an input data element I0,0-0 with coordinates (0, 0) and associated with the first channel (channel 0) at address C0 of local memory 1102. Controller 1108 may also fetch spatial sparsity map 912b from local memory 1102. Controller 1108 can determine, in operation 1164, whether the binary mask at coordinates (0, 0) of spatial sparsity map 912b equals one. If it does not, which indicates that the input data element is not to be fetched, controller 1108 can write an inactive value (e.g., zero) at address C0, in operation 1166. On the other hand, if the binary mask at coordinates (0, 0) of spatial sparsity map 912b equals one, controller 1108 can refer to entry 1134 of address table 1115 based on the entry being mapped to address C0 of local memory 1102, retrieve address C1 of off-chip external memory 1122 from entry 1134, and fetch input data element I0,0-0 from address C1 of off-chip external memory 1122 to address C0 of local memory 1102, in operation 1168.

In some examples, controller 1108 can select a subset of input data 1144 based on both channel sparsity map 912a and spatial sparsity map 912b. Specifically, referring to operation 1170 of FIG. 11D, controller 1108 may fetch both channel sparsity map 912a and spatial sparsity map 912b from local memory 1102. Controller 1108 may also determine, in operation 1172, whether the binary mask at coordinates (0, 0) of spatial sparsity map 912b equals one. If either the binary mask of channel sparsity map 912a for channel 0 or the binary mask of spatial sparsity map at coordinates (0, 0) is zero (determined in operation 1164), controller 1108 can write an inactive value (e.g., zero) at address C0, in operation 1166. If both binary masks equal one, controller 1108 can fetch input data element I_{0,0-0} from address C1 of off-chip external memory 1122 to address C0 of local memory 1102, in operation 1168.

FIG. 11E illustrates an example operation 1180 of controller 1108 in selectively fetching a subset of weights 1142 of DNN 810. Referring to FIG. 11E, controller 1108 may receive an instruction 1182 to store weights tensor [W₀₋₀] of the first channel at address A0 of local memory 1102. Controller 1108 may also fetch channel sparsity map 912a from local memory 1102. Controller 1108 can determine, in operation 1184, whether the binary mask of channel sparsity map 912a for channel 0 is one. If it is not, which indicates that input data and weights associated with channel 0 are not to be fetched, controller 1108 can write an inactive value (e.g., zero) at address A0, in operation 1186. On the other hand, if the binary mask at channel 0 equals one, controller 1108 can refer to entry 1130 of address table 1115 based on the entry being mapped to address A0 of local memory 1102, retrieve address A1 of off-chip external memory 1122 from entry 1130, and fetch weights tensor [W₀₋₀] from address A1 of off-chip external memory 1122 to address A0 of local memory 1102, in operation 1188.

After the fetching of input data and weights to local memory 1102 for a neural network completes, controller 1108 can control computation engine 1104 to fetch the input data and weights from local memory 1102 and perform computations for the neural network layer to generate intermediate outputs. Controller 1108 can also control output buffer 1106 to perform inter-group pooling operation 952a (e.g., average pooling, subsampling, etc.) on the intermediate outputs to generate a spatial tensor, and to perform a channel-wise pooling operation 952b on the intermediates outputs to generate a channel tensor, and store the spatial tensor and channel tensor back to off-chip external memory 1122 to support channel gating and/or spatial gating for the next neural network layer.

As described above, due to the channel gating and/or spatial gating, the input data and weights may include sparse input data and weights populated with inactive values (e.g., zeros) for subsets of input data and weights not fetched from off-chip external memory 1122. In some examples, to further reduce the computations involved in processing the sparse input data and weights, each processing element of computation engine 1104 can bypass circuits to skip computations when inactive values are received. FIG. 11F illustrates an example of processing element 1105 having bypass circuits. As shown in FIG. 11F, processing element 1105 may include a disable circuit 1190 and a multiplexor (MUX) 1192, in addition to multiplier 1116 and adder 1118. Disable circuit 1190 can disable multiplier 1116 and adder 1118 (e.g., by grounding their inputs) when at least one of input data element (i) or weight element (w) is an inactive value (e.g., zero), which means the product between i and w also has the inactive value, and the input partial sum p_in is not updated. Multiplexor 1192 can select between forwarding input partial sum p_in as output p_out, if at least one of i or w is an inactive value, or forwarding an updated partial sum by adding the product of i and w to input partial sum p_in, if both i and w have active/non-zero values.

### Example Image Sensor Including Dynamic Sparsity Image Processor

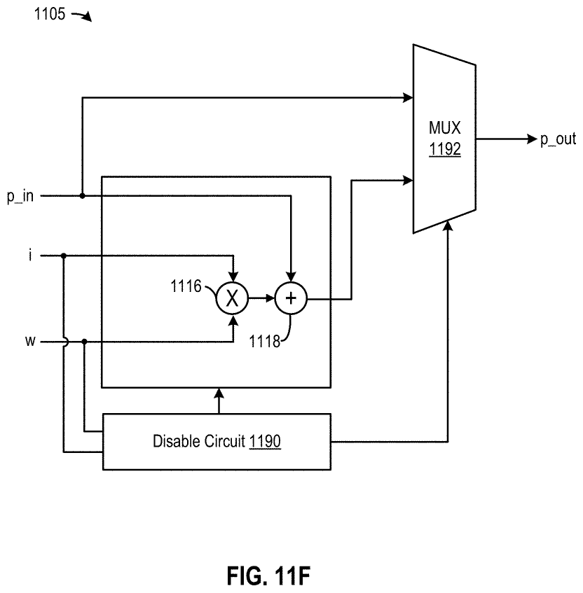

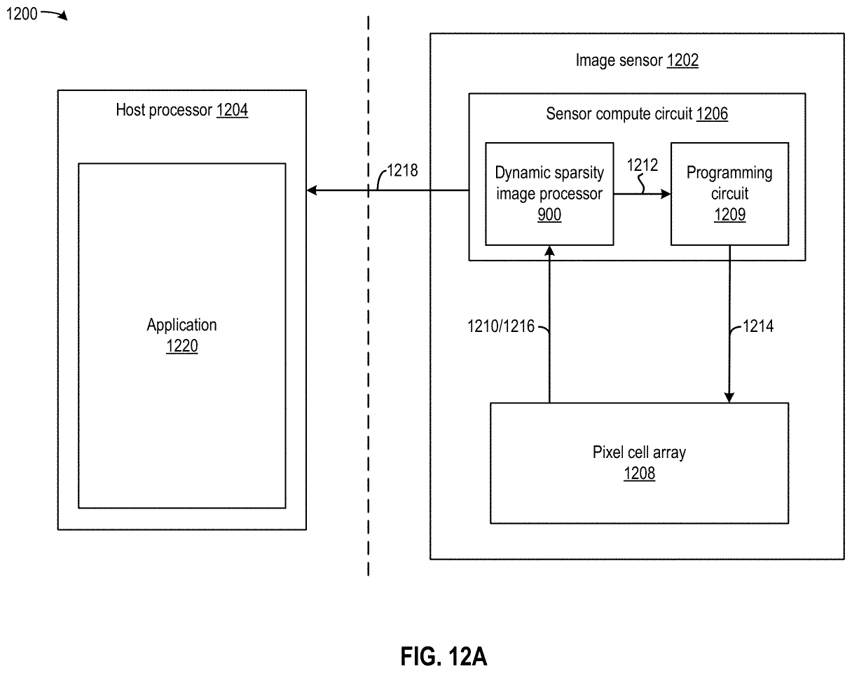

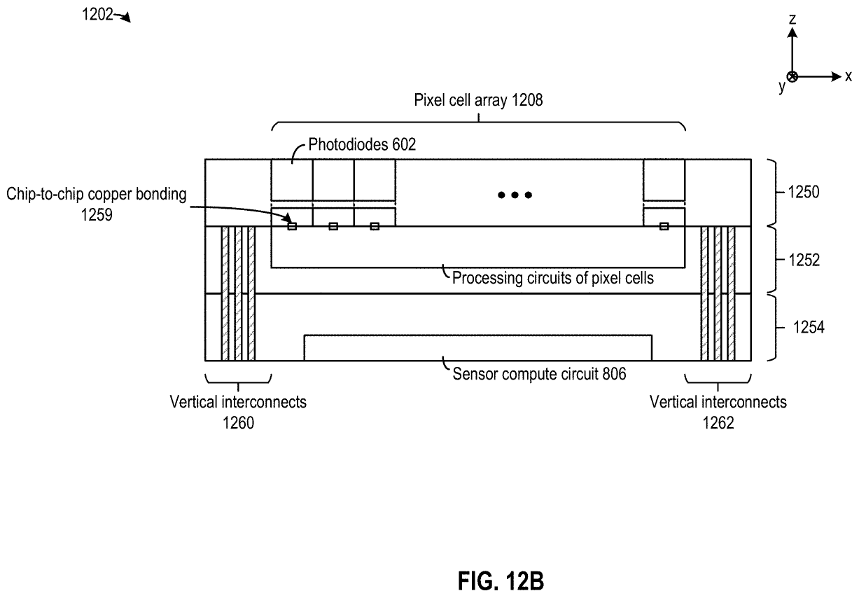

In some examples, dynamic sparsity image processor 900 can be part of an imaging system that also performs sparse image capturing operations. FIG. 12A and FIG. 12B illustrate examples of an imaging system 1200. As shown in FIG. 12A, imaging system 1200 includes an image sensor 1202 and a host processor 1204. Image sensor 1202 includes a sensor compute circuit 1206 and a pixel cell array 1208. Sensor compute circuit 1206 includes dynamic sparsity image processor 900 and a programming circuit 1209. Dynamic sparsity image processor 900 can receive a first image 1210 from pixel cells array 808 and perform a sparse image processing operation on first image 1210 to determine one or more regions of interest (ROI) including an object of interest, and transmit ROI information 1212 to programming circuit 1209. ROI information may indicate, for example, pixel locations of pixels of the ROI determined from first image 1210. Programming circuit 1209 can generate programming signals 1214 based on ROI information 1212 to selectively enable a subset of pixel cells of pixel cell array 1208 to capture a second image 1216 as part of a sparse image capturing operation. The selection of the subset of pixel cells can be based on, for example, the pixel locations of the ROI in first image 1210, an expected movement of the object of interest with respect to image sensor 1202 between the times when first image 1210 and second image 1216 are captured, etc. Dynamic sparsity image processor 900 can also transmit processing results 1218 of first image 1210 and second image 1216 (e.g., detection of the object of interest, a location of the object of interest, etc.) back to host processor 1204, which can host an application 1220 that consumes processing results 1218 to, for example, generate output contents.

In the example of FIG. 12A, imaging system 1200 can perform both a sparse image processing operation with dynamic sparsity image processor 900, and a sparse image capture operation with pixel cell array 1208 and based on outputs of dynamic sparsity image processor 900. Such arrangements can reduce the computation and memory resources, as well as power, used in capturing and processing of pixel data not useful for detection of an object of interest, which allows image system 1200 to be implemented on resource-constrained devices such as mobile devices, while allowing capturing and processing of images at a high resolution.

FIG. 12B illustrates examples of physical arrangements of image sensor 1202. As shown in FIG. 12B, image sensor 1202 may include a semiconductor substrate 1250 that includes some of the components of pixel cell array 1208, such as photodiodes 602 of the pixel cells, a semiconductor substrate 1252 that includes the processing circuits of pixel cell array 1208, such as buffer 606 and quantizer 607, and a semiconductor substrate 1254 that includes sensor compute circuit 1206, which may include neural network hardware accelerator 1100. Semiconductor substrates 1250, 1252, and 1254 can be housed within a semiconductor package to form a chip.

In some examples, semiconductor substrates 1250, 1252, and 1254 can form a stack along a vertical direction (e.g., represented by z-axis). Chip-to-chip copper bonding 1259 may be provided to provide pixel interconnects between photodiodes and processing circuits of the pixel cells, whereas vertical interconnects 1260 and 1262, such as through silicon vias (TSVs), micro-TSVs, Copper-Copper bumps, etc., can be provided between the processing circuits of the pixel cells and sensor compute circuit 1206. Such arrangements can reduce the routing distance of the electrical connections between pixel cell array 1208 and sensor compute circuit 1206, which can increase the speed of transmission of data (especially pixel data) from pixel cell array 1208 to sensor compute circuit 1206 and reduce the power required for the transmission.

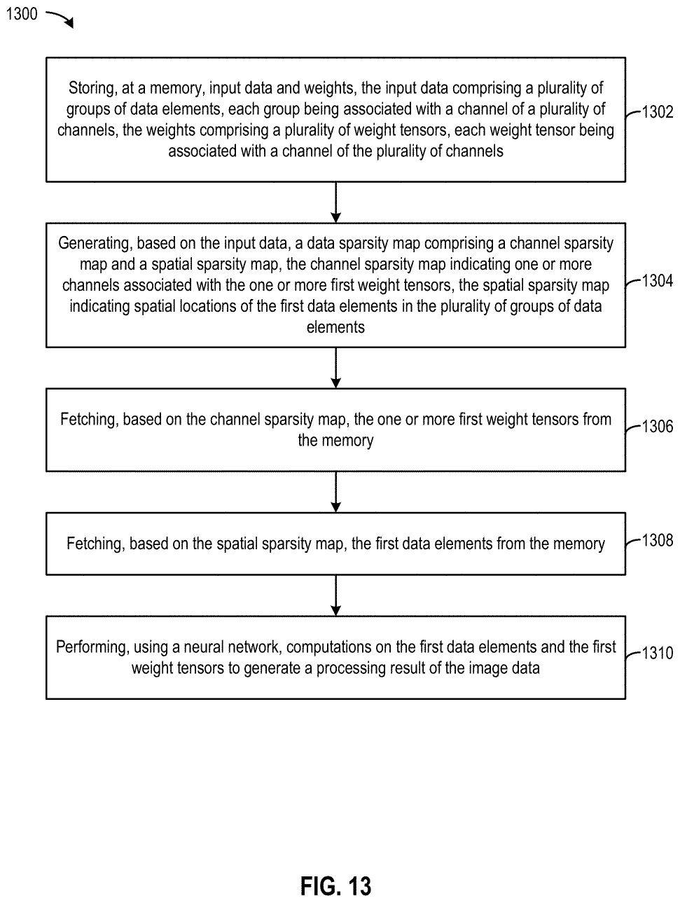

FIG. 13 illustrates an example of a flowchart of a method 1300 of performing a sparse image processing operation. Method 1300 can be performed by, for example, dynamic sparsity image processor 900, in conjunction with other components, such as sensor compute circuit 1206 and/or host processor 1204. In some examples, method 1300 can be performed by neural network hardware accelerator 1100 of FIG. 11A which can implement dynamic sparsity image processor 900.

Method 1300 starts with step 1302, in which input data and weights are stored in a memory. The in data comprising a plurality of groups of data elements, each group being associated with a channel of a plurality of channels, the weights comprising a plurality of weight tensors, each weight tensor being associated with a channel of the plurality of channels. In some examples, the input data may include image data, with each group of data elements representing an image of a particular wavelength channel, and a data element can represent a pixel value of the image. In some examples, the input data may also include features of a target object, with each group of data elements indicating absence/presence of certain features and the locations of the features in an image. The input data can be stored by, for example, host processor 1204, dynamic sparse image processing system 900, etc., in the memory that can be part of or external to the dynamic sparse image processing system.

In step 1302, dynamic sparsity image processor 900 generates, based on the input data, a data sparsity map comprising a channel sparsity map and a spatial sparsity map, the channel sparsity map indicating one or more channels associated with the one or more first weight tensors, the spatial sparsity map indicating spatial locations of the first data elements in the plurality of groups of data elements.

Specifically, as shown in FIG. 9B, the data sparsity map can include a channel sparsity map and a spatial sparsity map. The channel sparsity map may indicate one or more channels associated with one or more groups of data elements to be selected from the plurality of groups of data elements to support channel gating, whereas the spatial sparsity map can indicate spatial locations of the data elements in the one or more groups of data elements that are selected to be part of the first subset of the input data to support spatial gating. The spatial locations may include, for example, pixel locations in an image, coordinates in an input data tensor, etc. In some examples, both the channel sparsity map and the spatial sparsity map can include an array of binary masks, with each binary mask having one of two binary values (e.g., 0 and 1). The channel sparsity map can include a one-dimensional array of binary masks corresponding to the plurality of channels, with each binary mask indicating whether a particular channel is selected. Moreover, the spatial sparsity map can include a one-dimensional or two-dimensional array of binary masks corresponding to a group of data elements, with each binary mask indicating whether a corresponding data element of each group is selected to be part of the first subset of the input data.

The data sparsity map can be generated by data sparsity map generation circuit 902 of dynamic sparsity image processor 900. Data sparsity map generation circuit 902 can also generate a different spatial sparsity map and a different channel sparsity map for each layer of the image processing neural network. In some examples, spatial gating may be performed for some neural network layers, whereas channel gating may be performed for some other neural network layers. In some examples, a combination of both spatial gating and channel gating may be performed for some neural network layers. In some examples, data sparsity map generation circuit 902 can generate the sparsity maps based on compressed intermediate output data from the memory, as shown in FIG. 9D.

In some examples, referring to FIG. 10A-FIG. 10C, data sparsity map generation circuit 902 can use a machine learning model, such as a data sparsity map neural network, to learn about the patterns of features and channels in the input data to generate the data sparsity map. In some examples, the data sparsity map neural network may include a channel sparsity map neural network to generate a channel sparsity map from the channel tensor having groups/channels of compressed data elements, and a spatial sparsity map neural network to generate a spatial sparsity map from the spatial tensor having compressed channels. The channel sparsity map neural network may include multiple fully connected layers, while the spatial sparsity map neural network may include multiple convolution layers. The data sparsity map neural network may be trained using training data associated with reference/target outputs. The neural network can be trained to minimize differences between the outputs of the neural network and the reference/target outputs. In some examples, the data sparsity map neural network can employ reparameterization trick and approximation techniques, such as Gumbel-Softmax Trick, to generate the data sparsity map.

In step 1306, dynamic sparsity image processor 900 fetches, based on the channel sparsity map, the one or more first weight tensors from the memory. Moreover, in step 1308, dynamic sparsity image processor 900 fetches, based on the spatial sparsity map, the first data elements from the memory. Further, in step 1310, dynamic sparsity image processor 900 performs, using a neural network, computations on the first data elements and the first weight tensors to generate a processing result of the image data.

Specifically, as described above, the data map generation circuit and the image processing circuit can be implemented on neural network hardware accelerator 1100 of FIG. 11A, which can include on-chip local memory (e.g., static random-access memory (SRAM)), a computation engine, an output buffer, and a controller. The neural network hardware accelerator can also be connected to external circuits, such as a host and an external off-chip memory (e.g., dynamic random-access memory (DRAM)), via a bus. The on-chip local memory can store the input data and weights for a neural network layer. The controller may also store an address table, which can be in the form of a translation lookaside buffer (TLB), that translates between addresses of the external off-chip memory and the on-chip local memory. The TLB allows the controller to determine read addresses of the input data and weights at the external off-chip memory and their write addresses at the on-chip local memory, to support the fetching of the input data and weights from the external off-chip memory to the on-chip local memory. The controller can then control the computation engine to fetch the input data and weights from the on-chip local memory to perform the computations. After the output buffer completes the post-processing of the outputs of the computation engine and generates the intermediate output data, the controller can store the intermediate output data back to external off-chip memory as inputs to the next neural network layer, or as the final outputs of the neural network.

Prior to performing computations for an image processing neural network layer, the controller can first fetch the first set of weights of a data sparsity map neural network, as well as first and second compressed intermediate output data of a prior image processing neural network layer, from the off-chip external memory. The controller can then control the computing engine to perform neural network computations using the first set of weights and the first and second compressed intermediate output data to generate, respectively, the spatial sparsity map and the channel sparsity map for the image processing neural network layer, and store the spatial sparsity map and the channel sparsity map at the local memory.

Referring to FIG. 11B-FIG. 11E, the controller can combine the address table in the TLB with the spatial sparsity map and the channel sparsity map to generate read and write addresses to selectively fetch a subset of intermediate output data of the prior image processing neural network layer and a subset of the second set of weights of the current image processing neural network layer from the off-chip external memory to the local memory. In some examples, the controller can access the address table to access the read addresses of the second set of weights associated with different channels, and use the read addresses for weights associated with the channels selected in the channel sparsity map to fetch the subset of the second set of weights. In addition, the controller can also access the address table to access the read addresses of the intermediate output data of the prior image processing neural network layer, and use the read addresses for the intermediate output data elements selected in the spatial sparsity map and associated with the selected channels to fetch the subset of intermediate output data. The controller can also store a pre-determined inactive value, such as zero, for the remaining subsets of weights and intermediate output data that are not fetched in the local memory. The controller can then control the computation engine to fetch the weights and intermediate output data, including those that are fetched from the external memory and those that have zero values, from the local memory to perform computations of the current image processing neural network layer. In some examples, as shown in FIG. 11F, the computation engine may include circuits skip arithmetic operations on zero/inactive values.

The processing result can be used for different applications. For example, for an image capture by the array of pixel cells, a sparse image processing operation to detect an object of interest from the image, and determine a region of interest in a subsequent image to be captured by the array of pixel cells. The compute circuit can then selectively enable a subset of the array of pixel cells corresponding to the region of interest to capture the subsequent image as a sparse image, to perform a sparse image sensing operation. As another example, the object detection result can be provided to an application (e.g., a VR/AR/MR application) in the host to allow the application to update output content, to provide an interactive user experience.

Some portions of this description describe the examples of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, and/or hardware.

Steps, operations, or processes described may be performed or implemented with one or more hardware or software modules, alone or in combination with other devices. In some examples, a software module is implemented with a computer program product comprising a computer-readable medium containing computer program code, which can be executed by a computer processor for performing any or all of the steps, operations, or processes described.

Examples of the disclosure may also relate to an apparatus for performing the operations described. The apparatus may be specially constructed for the required purposes, and/or it may comprise a general-purpose computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples of the disclosure may also relate to a product that is produced by a computing process described herein. Such a product may comprise information resulting from a computing process, where the information is stored on a non-transitory, tangible computer-readable storage medium and may include any example of a computer program product or other data combination described herein.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the examples is intended to be illustrative, but not limiting, of the scope of the disclosure, which is set forth in the following claims.

That which is claimed is:

1. An apparatus comprising:
a memory configured to store input data and weights, the input data comprising a plurality of groups of data elements, each group being associated with a channel of a plurality of channels, the weights comprising a plurality of weight tensors, each weight tensor being associated with a channel of the plurality of channels;
a data sparsity map generation circuit configured to generate, based on the input data, a data sparsity map comprising a channel sparsity map and a spatial sparsity map, the channel sparsity map indicating one or more channels associated with one or more first weights tensors to be selected from the plurality of weight tensors, the spatial sparsity map indicating spatial locations of first data elements to be selected from the plurality of groups of data elements;
a gating circuit configured to:
fetch, based on the channel sparsity map, the one or more first weights tensors from the memory; and
fetch, based on the spatial sparsity map, the first data elements from the memory;
and
a processing circuit configured to perform, using a neural network, computations on the first data elements and the one or more first weights tensors to generate a processing result of the input data.

2. The apparatus of claim 1, wherein:
the neural network comprises a first neural network layer and a second neural network layer;
the gating circuit comprises a first gating layer and a second gating layer;
the first gating layer is configured to perform, based on a first data sparsity map generated based on the plurality of groups of data elements, at least one of:
a first channel gating operation on the plurality of weight tensors to provide first weights of the one or more first weights tensors to the first neural network layer, or
a first spatial gating operation on the plurality of groups of data elements to provide first input data including the first data elements to the first neural network layer;
the first neural network layer is configured to generate first intermediate outputs based on the first input data and the first weights, the first intermediate outputs having first groups of data elements associated with different channels;
the second gating layer is configured to perform, based on a second data sparsity map generated based on the first intermediate outputs, at least one of:
a second channel gating operation on the plurality of weight tensors to provide second weights of the one or more first weights tensors to the second neural network layer, or
a second spatial gating operation on the first intermediate outputs to provide second input data to the second neural network layer;
the second neural network layer is configured to generate second intermediate outputs based on the second input data and the second weights, the second intermediate outputs having second groups of data elements associated with different channels; and
the processing result is generated based on the second intermediate outputs.

3. The apparatus of claim 2, wherein:
the neural network further comprises a third neural network layer;
the gating circuit further comprises a third gating layer;
the third gating layer is configured to perform, based on a third data sparsity map generated based on the second intermediate outputs, at least one of:
a third channel gating operation on the plurality of weight tensors to provide third weights of the one or more first weights tensors to the third neural network layer, or
a third spatial gating operation on the second intermediate outputs to provide third input data to the third neural network layer; and
the third neural network layer is configured to generate outputs including the processing result based on the third input data and the third weights.

4. The apparatus of claim 3, wherein the second neural network layer comprises a convolution layer; and
wherein the third neural network layer comprises a fully connected layer.

5. The apparatus of claim 3, wherein:
the first gating layer is configured to perform the first spatial gating operation but not the first channel gating operation;
the second gating layer is configured to perform the second spatial gating operation but not the second channel gating operation; and
the third gating layer is configured to perform the third channel gating operation but not the third spatial gating operation.

6. The apparatus of claim 5, wherein the second data sparsity map is generated based on a spatial tensor, the spatial tensor being generated based on performing a channel-wise pooling operation between the first groups of data elements of the first intermediate outputs associated with different channels; and
wherein the third data sparsity map is generated based on a channel tensor, the channel tensor being generated based on performing an inter-group pooling operation within each group of the second groups of data elements of the second intermediate outputs, such that the channel tensor is associated with the same channels as the second intermediate outputs.

7. The apparatus of claim 1, wherein the neural network is a first neural network; and
wherein the data sparsity map generation circuit is configured to use a second neural network to generate the data sparsity map.

8. The apparatus of claim 7, wherein the data sparsity map comprises an array of binary masks, each binary mask having one of two values;
wherein the data sparsity map generation circuit is configured to:
generate, using the second neural network, an array of soft masks, each soft mask corresponding to a binary mask of the array of binary masks and having a range of values; and
generate the data sparsity map based on applying a differentiable function that approximates an arguments of the maxima (argmax) function to the array of soft masks.

9. The apparatus of claim 8, wherein the data sparsity map generation circuit is configured to:
add random numbers from a Gumbel distribution to the array of soft masks to generate random samples of the array of soft masks; and
apply a soft max function on the random samples to approximate the argmax function.

10. The apparatus of claim 1, wherein the data sparsity map generation circuit, the gating circuit, and the processing circuit are parts of a neural network hardware accelerator; and
wherein the memory is an external memory external to the neural network hardware accelerator.

11. The apparatus of claim 10, wherein the neural network hardware accelerator further includes a local memory, a computation engine, an output buffer, and a controller;
wherein the controller is configured to:
fetch, based on the channel sparsity map, the one or more first weights tensors from the external memory;
fetch, based on the spatial sparsity map, the first data elements from the external memory;
store the one or more first weights tensors and the first data elements at the local memory;
control the computation engine to fetch the one or more first weights tensors and the first data elements from the local memory, and to perform the computations of a first neural network layer of the neural network to generate intermediate outputs;
control the output buffer to perform post-processing operations on the intermediate outputs; and
store the post-processed intermediate outputs at the external memory to provide inputs for a second neural network layer of the neural network.

12. The apparatus of claim 11, wherein the local memory further stores an address table that maps between addresses of the local memory and addresses of the external memory; and
wherein the controller is configured to, based on the address table, fetch the one or more first weights tensors and the first data elements from the external memory and store the one or more first weights tensors and the first data elements at the local memory.

13. The apparatus of claim 12, wherein the address table comprises a translation lookaside buffer (TLB); and
wherein the TLB includes multiple entries, each entry being mapped to an address of the local memory, and each entry further storing an address of the external memory.

14. The apparatus of claim 13, wherein the controller is configured to:
receive a first instruction to store a data element of the plurality of groups of data elements at a first address of the local memory, the data element having a first spatial location in the plurality of groups of data elements;
determine, based on the spatial sparsity map, that the data element at the first spatial location is to be fetched; and
based on determining that the data element at the first spatial location is to be fetched:
retrieve a first entry of the address table mapped to the first address;
retrieve a second address stored in the first entry;
fetch the data element from the second address of the external memory; and
store the data element at the first address of the local memory.

15. The apparatus of claim 13, wherein the controller is configured to:
receive a second instruction to store a weight tensor of the plurality of weight tensors at a third address of the local memory, the weight tensor being associated with a first channel of the plurality of channels;
determine, based on the channel sparsity map, that a weight tensor of the first channel is to be fetched; and
based on determining that the weight tensor of the first channel is to be fetched:
retrieve a second entry of the address table mapped to the third address;
retrieve a fourth address stored in the second entry;
fetch the weight tensor from the fourth address of the external memory; and
store the weight tensor at the third address of the local memory.

16. The apparatus of claim 11, wherein the neural network is a first neural network;
wherein the channel sparsity map is a first channel sparsity map;
wherein the spatial sparsity map is a first spatial sparsity map;
wherein the controller is configured to:
control the output buffer to generate a channel tensor based on performing an inter-group pooling operation on the intermediate outputs;
control the output buffer to generate a spatial tensor based on performing a channel-wise pooling operation on the intermediate outputs;
store the channel tensor, the spatial tensor, and the intermediate outputs at the external memory;
fetch the channel tensor and the spatial tensor from the external memory;
fetch weights associated with a channel sparsity map neural network and a spatial sparsity map neural network from the external memory;
control the computation engine to perform computations of the channel sparsity map neural network on the channel tensor to generate a second channel sparsity map;
control the computation engine to perform computations of the spatial sparsity map neural network on the spatial tensor to generate a second spatial sparsity map; and
perform at least one of: a channel gating operation on the plurality of weight tensors to fetch second weights of the one or more first weights tensors to a second neural network layer of the first neural network, or a spatial gating operation on the intermediate outputs to provide second input data to the second neural network layer of the first neural network.

17. The apparatus of claim 1, further comprising a programmable pixel cell array and a programming circuit;
wherein the input data is first input data; and
wherein the programming circuit is configured to:
determine a region of interest based on the processing result from the processing circuit;
generate a programming signal indicating the region of interest to select a subset of pixel cells of the programmable pixel cell array to perform light sensing operations to perform a sparse image capture operation; and
transmit the programming signal to the programmable pixel cell array to perform the sparse image capture operation to capture second input data.

18. The apparatus of claim 17, wherein the data sparsity map generation circuit, the gating circuit, the processing circuit, and the programmable pixel cell array are housed within a chip package to form a chip.

19. A method comprising:
storing, at a memory, input data and weights, the input data comprising a plurality of groups of data elements, each group being associated with a channel of a plurality of channels, the weights comprising a plurality of weight tensors, each weight tensor being associated with a channel of the plurality of channels;
generating, based on the input data, a data sparsity map comprising a channel sparsity map and a spatial sparsity map, the channel sparsity map indicating one or more channels associated with one or more first weights tensors to be selected from the plurality of weight tensors, the spatial sparsity map indicating spatial locations of first data elements to be selected from the plurality of groups of data elements;
fetching, based on the channel sparsity map, the one or more first weights tensors from the memory;
fetching, based on the spatial sparsity map, the first data elements from the memory; and
performing, using a neural network, computations on the first data elements and the one or more first weights tensors to generate a processing result of the input data.

20. The method of claim 19, wherein the neural network is a first neural work; and wherein the data sparsity map is generated using a second neural network.
